(19) United States
(12) Patent Application Publication
(10) Pub. No.: US 2025/0378370 A1
(43) Pub. Date: Dec. 11, 2025

(54) MACHINE LEARNING MODEL MONITORING

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US); Mahmoud TAHERZADEH BOROUJENI, San Diego, CA (US)

(21) Appl. No.: 18/737,378

(22) Filed: Jun. 7, 2024

(51) Int. Cl. G06N 20/00

(52) U.S. Cl. CPC G06N 20/00

(57) ABSTRACT

Methods, systems, and devices for wireless communications are described. A first device may obtain measurement information for a prediction target associated with one or more machine learning models. The one or more machine learning models may be associated with one or more respective sets of training input information and one or more respective sets of training measurement information. The first device may compare a first statistical distribution corresponding to the measurement information to one or more second statistical distributions corresponding to the one or more respective sets of training measurement information to obtain one or more similarity metrics. The first device may generate one or more inferences using a first machine learning model from among the one or more machine learning models, where the first machine learning model is selected in accordance with the one or more similarity metrics.

### FIELD OF TECHNOLOGY

The following relates to wireless communications, including machine learning model monitoring.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

Prior to their deployment in a user equipment (UE) in a wireless communications system, ML models may be trained using training information. If the UE is operating in conditions which are different from training conditions used to train a ML model, performance of the ML model may degrade. For example, inferences generated using the ML model may be less accurate when the UE is operating in different conditions. The UE or the network entity, or both, may monitor for a discrepancy between data and a ML model (e.g., data drift) after the ML model is deployed. If the UE or the network entity detects drift, the UE may switch to a different ML model which better matches the operating conditions of the UE. Some drift monitoring techniques may be unable to detect some types of drift or may involve significant overhead (e.g., associated with the execution of each model being monitored).

Techniques described herein support the detection of data drift by comparing training measurement information to actual measurement information of prediction targets. For example, a UE may measure a reference signals associated with a prediction target to determine a first statistical distribution of actual measurements for the prediction target. The UE may compare the first statistical distribution of actual measurements to one or more second statistical distributions of training measurements included in the training data for one or more ML models. The UE may determine whether the UE is experiencing data drift based on a comparison of the first statistical distribution of the actual measurements to the statistical distributions of the training measurement information. The UE may perform one or more procedures based on the comparison. In some examples, the UE may be configured with a similarity threshold, and the UE may perform the one or more procedures according to whether the similarity satisfies the similarity threshold. For example, the UE may continue to use the same ML model, change the ML model used for inference, obtain additional training information for a ML model, or disable inferences or ML techniques.

A method for wireless communications by a first device is described. The method may include obtaining measurement information for a prediction target associated with one or more machine learning (ML) models, the one or more ML models associated with one or more respective sets of training input information and one or more respective sets of training measurement information, comparing a first statistical distribution corresponding to the measurement information to one or more second statistical distributions corresponding to the one or more respective sets of training measurement information to obtain one or more similarity metrics, and generating one or more inferences using a first ML model from among the one or more ML models, where the first ML model is selected in accordance with the one or more similarity metrics.

A first device for wireless communications is described. The first device may include one or more memories storing processor executable code, and one or more processors coupled with the one or more memories. The one or more processors may individually or collectively be operable to execute the code to cause the first device to obtain measurement information for a prediction target associated with one or more ML models, the one or more ML models associated with one or more respective sets of training input information and one or more respective sets of training measurement information, compare a first statistical distribution corresponding to the measurement information to one or more second statistical distributions corresponding to the one or more respective sets of training measurement information to obtain one or more similarity metrics, and generate one or more inferences using a first ML model from among the one or more ML models, where the first ML model is selected in accordance with the one or more similarity metrics.

Another first device for wireless communications is described. The first device may include means for obtaining measurement information for a prediction target associated with one or more ML models, the one or more ML models associated with one or more respective sets of training input information and one or more respective sets of training measurement information, means for comparing a first statistical distribution corresponding to the measurement information to one or more second statistical distributions corresponding to the one or more respective sets of training measurement information to obtain one or more similarity metrics, and means for generating one or more inferences using a first ML model from among the one or more ML models, where the first ML model is selected in accordance with the one or more similarity metrics.

A non-transitory computer-readable medium storing code for wireless communications is described. The code may include instructions executable by one or more processors to obtain measurement information for a prediction target associated with one or more ML models, the one or more ML models associated with one or more respective sets of training input information and one or more respective sets of training measurement information, compare a first statistical distribution corresponding to the measurement information to one or more second statistical distributions corresponding to the one or more respective sets of training measurement information to obtain one or more similarity metrics, and generate one or more inferences using a first ML model from among the one or more ML models, where the first ML model is selected in accordance with the one or more similarity metrics.

In some examples of the method, first devices, and non-transitory computer-readable medium described herein, the first statistical distribution may correspond to input information associated with the measurement information, and the one or more second statistical distributions correspond to the one or more respective sets of training input information.

In some examples of the method, first devices, and non-transitory computer-readable medium described herein, obtaining the measurement information may include operations, features, means, or instructions for receiving a reference signal associated with the prediction target, where the measurement information may be associated with a measurement of the reference signal via the prediction target.

Some examples of the method, first devices, and non-transitory computer-readable medium described herein may further include operations, features, means, or instructions for switching from using a second ML model to using the first ML model in accordance with the one or more similarity metrics.

Some examples of the method, first devices, and non-transitory computer-readable medium described herein may further include operations, features, means, or instructions for monitoring, in accordance with the one or more similarity metrics, for reference signals associated with the prediction target to obtain additional input information and additional measurement information for the first ML model and adjusting the first ML model or a corresponding statistical distribution for the first ML model, or both, in accordance with the additional input information and the additional measurement information.

Some examples of the method, first devices, and non-transitory computer-readable medium described herein may further include operations, features, means, or instructions for receiving a first message indicating one or more similarity metric thresholds and comparing the one or more similarity metrics to the one or more similarity metric thresholds, where the first ML model may be selected in accordance with comparing the one or more similarity metrics to the one or more similarity metric thresholds.

Some examples of the method, first devices, and non-transitory computer-readable medium described herein may further include operations, features, means, or instructions for transmitting a second message indicative that the one or more similarity metrics satisfy the one or more similarity metric thresholds in accordance with the comparing and receiving a third message indicating the first ML model from among the one or more ML models in response to second message.

In some examples of the method, first devices, and non-transitory computer-readable medium described herein, the second message includes at least one of the one or more similarity metrics.

Some examples of the method, first devices, and non-transitory computer-readable medium described herein may further include operations, features, means, or instructions for transmitting a control message indicating at least one of the one or more similarity metrics, the first statistical distribution associated with the measurement information, or any combination thereof.

Some examples of the method, first devices, and non-transitory computer-readable medium described herein may further include operations, features, means, or instructions for receiving downlink control information scheduling a resource for the control message, where the control message may be transmitted via the resource.

Some examples of the method, first devices, and non-transitory computer-readable medium described herein may further include operations, features, means, or instructions for transmitting a capability message that indicates a capability of the first device to compare the first statistical distribution associated with the measurement information to the one or more second statistical distributions.

In some examples of the method, first devices, and non-transitory computer-readable medium described herein, the capability of the first device may be associated with beam inferences, channel state information compression, positioning inferences, or any combination thereof.

A method for wireless communications by a second device is described. The method may include outputting a reference signal associated with a prediction target for one or more ML models, the one or more ML models associated with one or more respective sets of training input information and one or more respective sets of training measurement information, obtaining first control message indicating one or more similarity metrics associated with comparison between a first statistical distribution corresponding to measurement information for the prediction target and one or more second statistical distributions corresponding to the one or more respective sets of training measurement information, and outputting a second control message indicating a configuration for a first ML model from among the one or more ML models, where the first ML model is selected in accordance with the one or more similarity metrics.

A second device for wireless communications is described. The second device may include one or more memories storing processor executable code, and one or more processors coupled with the one or more memories. The one or more processors may individually or collectively be operable to execute the code to cause the second device to output a reference signal associated with a prediction target for one or more ML models, the one or more ML models associated with one or more respective sets of training input information and one or more respective sets of training measurement information, obtain first control message indicating one or more similarity metrics associated with comparison between a first statistical distribution corresponding to measurement information for the prediction target and one or more second statistical distributions corresponding to the one or more respective sets of training measurement information, and output a second control message indicating a configuration for a first ML model from among the one or more ML models, where the first ML model is selected in accordance with the one or more similarity metrics.

Another second device for wireless communications is described. The second device may include means for outputting a reference signal associated with a prediction target for one or more ML models, the one or more ML models associated with one or more respective sets of training input information and one or more respective sets of training measurement information, means for obtaining first control message indicating one or more similarity metrics associated with comparison between a first statistical distribution corresponding to measurement information for the prediction target and one or more second statistical distributions corresponding to the one or more respective sets of training measurement information, and means for outputting a second control message indicating a configuration for a first ML model from among the one or more ML models, where the first ML model is selected in accordance with the one or more similarity metrics.

A non-transitory computer-readable medium storing code for wireless communications is described. The code may include instructions executable by one or more processors to output a reference signal associated with a prediction target for one or more ML models, the one or more ML models associated with one or more respective sets of training input information and one or more respective sets of training measurement information, obtain first control message indicating one or more similarity metrics associated with comparison between a first statistical distribution corresponding to measurement information for the prediction target and one or more second statistical distributions corresponding to the one or more respective sets of training measurement information, and output a second control message indicating a configuration for a first ML model from among the one or more ML models, where the first ML model is selected in accordance with the one or more similarity metrics.

In some examples of the method, second devices, and non-transitory computer-readable medium described herein, the first statistical distribution corresponds to input information associated with the measurement information, and the one or more second statistical distributions correspond to the one or more respective sets of training input information.

In some examples of the method, second devices, and non-transitory computer-readable medium described herein, the configuration for the first ML model indicates to use the first ML model, to disable the first ML model, to adjust the first ML model, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports machine learning (ML) model monitoring in accordance with one or more aspects of the present disclosure.

FIG. 2 shows an example of an ML model represented by an artificial neural network (ANN) that supports ML model monitoring in accordance with one or more aspects of the present disclosure.

FIG. 3 shows an example of an ML architecture that supports ML model monitoring in accordance with one or more aspects of the present disclosure.

FIG. 4 shows an example of a wireless communications system that supports ML model monitoring in accordance with one or more aspects of the present disclosure.

FIG. 5 shows an example of a drift detection technique that supports ML model monitoring in accordance with one or more aspects of the present disclosure.

FIG. 6 shows an example of a data distribution comparison that supports ML model monitoring in accordance with one or more aspects of the present disclosure.

FIG. 7 shows an example of a process flow that supports ML model monitoring in accordance with one or more aspects of the present disclosure.

FIGS. 8 and 9 show block diagrams of devices that support ML model monitoring in accordance with one or more aspects of the present disclosure.

FIG. 10 shows a block diagram of a communications manager that supports ML model monitoring in accordance with one or more aspects of the present disclosure.

FIG. 11 shows a diagram of a system including a device that supports ML model monitoring in accordance with one or more aspects of the present disclosure.

FIGS. 12 and 13 show block diagrams of devices that support ML model monitoring in accordance with one or more aspects of the present disclosure.

FIG. 14 shows a block diagram of a communications manager that supports ML model monitoring in accordance with one or more aspects of the present disclosure.

FIG. 15 shows a diagram of a system including a device that supports ML model monitoring in accordance with one or more aspects of the present disclosure.

FIGS. 16 through 18 show flowcharts illustrating methods that support ML model monitoring in accordance with one or more aspects of the present disclosure.

### DETAILED DESCRIPTION

In some wireless communications systems, a wireless device, such as a user equipment (UE), may use artificial intelligence and machine learning (ML) to perform inferences for wireless communication. The UE may be configured with multiple ML models, and the UE may use the ML models for beam prediction, positioning inferences, and the like. For example, the UE may obtain a measurement of a measurement target, and the UE may input the measurement of the measurement target to an ML model to predict a measurement for a prediction target. Prior to their deployment in a UE in a wireless communications system, ML models may be trained using training information. Training information for an ML model may include training input information (e.g., model inputs used to train the ML model) as well as training measurement information (e.g., actual measurements of prediction targets that the model would try to predict in association with training the ML model, and which may alternatively be referred to as label information). If the UE is operating in conditions which are different from training conditions used to train a ML model, performance of the ML model may degrade. For example, inferences generated using the ML model may be less accurate when the UE is operating in different conditions. The UE or the network entity, or both, may monitor for a discrepancy between data and a ML model (e.g., data-concept drift) after the ML model is deployed. If the UE or the network entity detects drift, the UE may switch to a different ML model which better matches the operating conditions of the UE.

In some examples, a UE may compare input information for measurement targets with training input information to detect some types of drift. For example, the UE may measure reference signals used for inputs to the ML model (e.g., corresponding to measurement targets) to generate a statistical distribution of the input information and compare the statistical distribution of the input information to statistical distributions of the training input information for the ML models. However, comparing input information to training input information may not be able to detect all types of drift, such as when drift causes a change in a decision boundary. While a UE may be able to detect drift and identify a more efficient or accurate ML model by performing inferences using all ML models configured at the UE, using a ML model to obtain inferences in support of monitoring the model outputs has high complexity and uses a large amount of energy at the UE, especially when the UE evaluates multiple ML models.

A wireless communications system described herein supports techniques to detect data drift by comparing training measurement information to actual measurement information of prediction targets. For example, the UE may measure a reference signals associated with a prediction target to determine a first statistical distribution of actual measurements for the prediction target. The UE may compare the first statistical distribution of actual measurements to one or more second statistical distributions of training measurements for one or more ML models. The UE may determine whether the UE is experiencing data drift based on a comparison of the first statistical distribution of the actual measurements to the statistical distributions of the training measurement information. The UE may perform one or more procedures based on the comparison. In some examples, the UE may be configured with a similarity threshold, and the UE may perform the one or more procedures according to whether the similarity satisfies the similarity threshold. For example, the UE may continue to use the same ML model, change the ML model used for inference, obtain additional training information for a ML model, or disable inferences or ML techniques. In some examples, the UE may report a capability to monitor ML model performance based on measurement information comparisons. The UE may report information associated with the comparisons, such as whether the similarity satisfies the similarity threshold or a similarity metric obtained from the comparison. In some examples, the network may configure the UE to perform one or more of the operations based on the reported similarity or similarity metric.

Aspects of the disclosure are initially described in the context of wireless communications systems. Aspects of the disclosure are further illustrated by and described with reference to an ML model, an ML architecture, a drift detection technique, a distribution comparison, a process flow, apparatus diagrams, system diagrams, and flowcharts that relate to ML model monitoring.

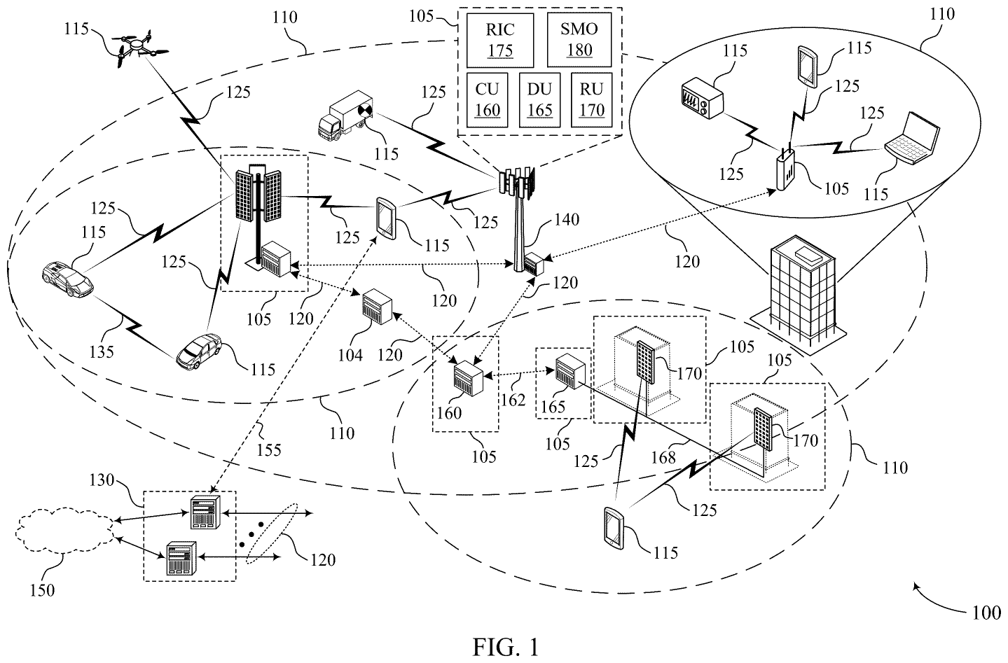

FIG. 1 shows an example of a wireless communications system 100 that supports ML model monitoring in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHZ)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A wireless device, such as a UE 115 or a network entity 105, may use artificial intelligence and ML to obtain inferences for wireless communication. For example, a UE 115 may be configured with one or more ML models. The UE 115 may provide input to an ML model, and the ML model may output a prediction or an inference for a prediction target. For example, the UE 115 may measure reference signals via a first set of beams (e.g., wide beams), and the UE 115 may input measurements of the reference signals to an ML model. The ML model may output a predicted measurement for a second set of beams (e.g., narrow beams). In some examples, resources used to measure the reference signals and obtain the input information may be referred to as measurement targets, and resources for which the ML model performs the prediction may be referred to as prediction targets.

A wireless device, such as the UE 115 or the network entity 105, or both, may monitor a performance of an ML model. For example, the wireless device may monitor for any mismatch between data and an ML model, which may result in data/concept drift after the ML model has been deployed. An ML model may be associated with a certain data distribution, such as the distribution of a training data set, for which the ML model is designed to operate. If the operating conditions at a UE 115 are different from conditions under which the ML model was trained, performance of the ML model may degrade, such as by generating less accurate predictions.

Data drift to a UE 115 may be caused by factors that affect properties of the input-output to an ML model at the UE 115. For example, the UE 115 may experience different SINR levels of an input reference signal than those used in training the model. Additionally, or alternatively, a network entity 105 using a different scheduling mode (e.g., single-user scheduling or multi-user scheduling) may cause data drift at the UE 115. In some examples, receiving a different type of reference signal, or use of an ML model to generate inferences for a different type of reference signal than what was used to train the ML model, may cause drift. In some examples, changes to operating conditions, such as an operating bandwidth, radio frequency spectrum band, or beam, may cause data drift. In some cases, a different energy per resource element (EPRE) may cause data drift. In some cases, using a different beam codebook, quantity of antenna ports, quantity of panels, or quantity of antenna elements may cause data drift. In some examples, a change to an environment (e.g., going from a rural environment to an urban environment, a high Doppler scenario to a low Doppler scenario, a high interference to a low interference scenario, etc.) may cause data drift.

If the wireless device detects data drift, the wireless device may change ML operation. For example, if a UE 115 experiences data drift, the UE 115 may switch to a different ML model or disable ML model use. In some examples, the UE 115 may activate or deactivate branches in the ML model. In some examples, the UE 115 may train a global ML model that generalizes well under different conditions. For example, the UE 115 may train a model for the conditions in which the UE 115 is operating to obtain an efficient ML model for those conditions. In some examples, the UE 115 may perform online re-training or finetuning of one or more ML models.

As an ML model is trained in a specific environment or using a specific configuration, that environment or configuration may affect a distribution of the ML model inputs (e.g., measurements of measurement targets) and model outputs (e.g., inferences for prediction targets). During inference, by observing the input, output, or joint input-output data distributions, the monitoring algorithm may observe variations in the statistics of the input and output of the ML model. This may result in the ML model being inapplicable to the current scenario. The monitoring algorithm may monitor a distribution similarity or distance between the inference input data distribution and the different input distributions of the different ML models. High distribution similarity between the training information and the inference data distributions may indicate that the ML model is applicable to the current environment, while a low distribution similarity may indicate that the ML model is not applicable to the current environment.

In some examples, a UE 115 may monitor an ML model to detect data drift based on input data distributions. For example, a UE 115 may be configured with three trained ML models for temporal beam prediction. The UE 115 may determine normalized input RSRP measurement distributions for each ML model based on training information for the ML models. These distributions may be referred to as training input data distribution or statistical distributions associated with training input information. For example, a first ML model may have a first normalized data distribution based on input information used to train the first ML model, and the second ML model may have a second normalized data distribution based on input information used to train the second ML model. However, the conditions or environments used to train the first ML model and the second ML model may be different, such that the first normalized data distribution and the second normalized data distribution are different. For example, a mean RSRP measurement for an ML model trained in an indoor environment may be higher than a mean RSRP measurement for an ML model trained in an outdoor environment.

During an inference phase, the UE 115 may obtain RSRP measurements to be used as input information to an ML model. For example, the UE 115 may measure reference signals via measurement targets to obtain the RSRP measurements. The UE may determine a normalized data distribution of the input information obtained during the inference phase. This distribution may be referred to as an inference data distribution or a statistical distribution associated with input information.

The UE 115 or the network entity 105, or both, may compare the training input data distribution (e.g., the distribution of RSRPs used in training different ML models) with the inference data distribution (e.g., RSRP measurements observed during inference) to determine which ML model is better suited for the current inference environment or operating conditions of the UE 115. For example, a high distribution similarity between the training input data distribution and an inference data distribution may indicate that an ML model was trained under similar conditions or in a similar environment to the current conditions or environment of the UE, as the input information obtained during the inference phase is similar to the training input information. A low distribution similarity may indicate that the current conditions or environment of the UE 115 are different from the environment or conditions used to train the ML model.

While monitoring ML performance based on input data distributions may be able to detect some types of data drift, data drift which causes a change to a decision boundary may not be reliably detected based on input data distributions. Monitoring ML performance by monitoring a joint input-output data distribution may be able to detect all types of data drift (e.g., including data drift which causes a decision boundary change), monitoring an ML model using output information (e.g., inference outputs, which may alternatively be referred to as model outputs) of the ML model may require using the ML model to generate the output information.

The wireless communications system 100 supports techniques to detect data drift by comparing training measurement information to actual measurement information of prediction targets. For example, the UE 115 may measure reference signals associated with a prediction target to determine a first statistical distribution of actual measurements for the prediction target. The UE 115 may compare the first statistical distribution of actual measurements to one or more second statistical distributions of training measurements, or labels, for one or more ML models. The UE 115 may determine whether the UE 115 is experiencing data drift based on a comparison of the first statistical distribution of the actual measurements to the statistical distributions of the training measurement information.

The UE 115 may perform one or more procedures based on the comparison. In some examples, the UE 115 may be configured with a similarity threshold, and the UE 115 may perform the one or more procedures according to whether the similarity satisfies the similarity threshold. For example, the UE 115 may continue to use the same ML model, change the ML model used for inference, obtain additional training information for a ML model, or disable inferences or ML techniques. In some examples, the UE 115 may report a capability to monitor ML model performance based on measurement information comparisons. The UE 115 may report information associated with the comparisons, such as whether the similarity satisfies the similarity threshold or a similarity metric obtained from the comparison. In some examples, the network may configure the UE 115 to perform one or more of the operations based on the reported similarity or similarity metric.

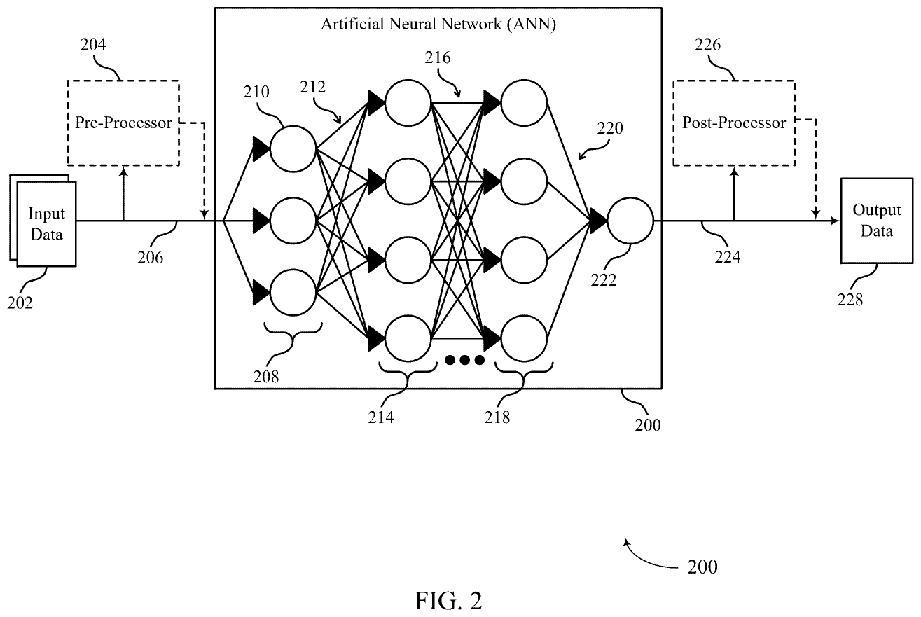

FIG. 2 shows an example ML (ML) model represented by an artificial neural network (ANN) 200. ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of ANN 200. Pre-processor 204 may be included within ANN 200 in some other implementations. Pre-processor 204 may, for example, process all or a portion of data 202 which may result in some of data 202 being changed, replaced, deleted, etc. In some implementations, pre-processor 204 may add additional data to data 202. In some implementations, the pre-processor 204 may be a ML model, such as an ANN.

ANN 200 includes at least one first layer 208 of artificial neurons 210 to process input data 206 and provide resulting first layer data via connections or “edges” such as edges 212 to at least a portion of at least one second layer 214. Second layer 214 processes data received via edges 212 and provides second layer output data via edges 216 to at least a portion of at least one third layer 218. Third layer 218 processes data received via edges 216 and provides third layer output data via edges 220 to at least a portion of a final layer 222 including one or more neurons to provide output data 224. All or part of output data 224 may be further processed in some manner by (optional) post-processor 226. Thus, in certain examples, ANN 200 may provide output data 228 that is based on output data 224, post-processed data output from post-processor 226, or some combination thereof.

Post-processor 226 may be included within ANN 200 in some other implementations. Post-processor 226 may, for example, process all or a portion of output data 224 which may result in output data 228 being different, at least in part, to output data 224, as result of data being changed, replaced, deleted, etc. In some implementations, post-processor 226 may be configured to add additional data to output data 224. In this example, second layer 214 and third layer 218 represent intermediate or hidden layers that may be arranged in a hierarchical or other like structure. Although not explicitly shown, there may be one or more further intermediate layers between the second layer 214 and the third layer 218. In some implementations, the post-processor 226 may be a ML model, such as an ANN.

The structure and training of artificial neurons 210 in the various layers may be tailored to specific requirements of an application. Within a given layer such as first layer 208, second layer 214, or third layer 218 of ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 200. The weights and biases of ANN 200 may be adjusted during a training process or during operation of ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 200, may be conducted using training data. Training data may include one or more datasets which ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may be repeated multiple times to finetune ANN 200 with each iteration.

ANN 200 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed.

In example aspects, an ML model may be trained prior to, or at some point following, operation of the ML model, such as ANN 200, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

For example, one or more ML models may be trained at a UE for temporal beam prediction. The training data may be organized into normalized input data distributions, such as RSRP measurement distributions. RSRP measurements used in training different ML models may have different distributions, as the different ML models may be trained in different environments or at different operating conditions of the UE. For example, a mean RSRP measurement of an ML model trained in an indoor environment may be higher than a mean RSRP measurement of an ML model trained in an outdoor environment.

In some cases, to train an ML model, a UE may perform a first set of measurements for a set of measurement targets and measure a prediction target. The first set of measurements for the set of measurement targets may correspond to training input information. For example, the UE may measure one or more reference signals via the set of measurement targets. The UE may measure a reference signal via the prediction target to obtain label information or ground-truth information for the prediction target. For example, when performing inference, the UE may feed input information obtained via measurement targets to generate an inference for a prediction target. In some examples, to train an ML model, the UE may measure the prediction target to obtain a ground-truth label for the prediction target and determine an actual measurement of the prediction target. For example, training data for an ML model at a UE may include training input information, such as measurement information associated with a measurement target, and training measurement information, such as label information or measurement information associated with a prediction target.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pretrained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model. In some examples, different levels of collaboration between the devices may be possible.

For example, during an inference phase, a UE may start measuring RSRP measurements. The RSRP measurements may correspond to input data for an ML model. The RSRP measurements may be organized into a normalized statistical distribution. The UE may compare input training data distributions for one or more ML models, corresponding to a distribution of RSRP measurements used in training the one or more ML models, with a normalized data distribution for RSRP measurements obtained during inference. The UE may determine which ML model is better suited for a current inference environment or operating condition based on the comparison. For example, the UE may compare a first statistical distribution of inputs obtained during inference to a second statistical distribution of training data inputs and identify which ML model was trained in most-similar conditions. If an ML model was trained in similar conditions to the conditions experienced at the UE when during an inference phase, the statistical distribution of the training inputs may be similar to the statistical distribution of inputs obtained during the inference phase.

A UE may use one of multiple different approaches to evaluate a similarity between a first statistical distributions obtained during an inference phase and a second statistical distribution for training data. In some examples, the UE may calculate a Kullback-Leibler (KL) divergence to determine a similarity between statistical data distributions. In some examples, the UE may calculate a Kolmogorov-Smirnov (KS) distance between the statistical data distributions. In some examples, the UE may determine an Earth mover's distance between the statistical data distributions.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

An ML model may have stringent requirements on input-output statistical properties. For example, the performance of an ML model trained in a specific environment or under specific operating conditions may degrade as the environment or operating conditions of a UE change. The UE may be configured with multiple pretrained ML models to account for different environments and operating conditions. In some examples, monitoring the performance of all ML models configured at the UE may be associated with high complexity, as the UE may generate inferences with each ML model to monitor the performance of each ML model.

A change to operating conditions or environment of a UE may be referred to as data drift. Monitoring the ML models at the UE may enable the UE to detect data drift and test the suitability of an ML model after data drift is detected. For example, a UE may be configured with two-dimensional data X={x₁, x₂} with two class labels y={y₀, y₁}. A first source of data drift may occur when Pₜᵣₐᵢₙ(X)≠P_{inference}(X), but Pₜᵣₐᵢₙ(y|X)=P_{inference}(y|X). A second source of data drift may occur when Pₜᵣₐᵢₙ(y|X)≠P_{inference}(y|X) but Pₜᵣₐᵢₙ(X)=P_{inference}(X). A third source of data drift may occur when Pₜᵣₐᵢₙ(y|X)≠P_{inference}(y|X) and Pₜᵣₐᵢₙ(X)≠P_{inference}(X). Different techniques for ML model monitoring may be able to detect different types of data drift. For example, monitoring an ML model based on input data distributions may be able to detect the first source of data drift and the third source of data drift but may be unable to detect decision boundary data drifts, such as the second source of data drift. However, monitoring an ML model based on input data distributions may not require running the ML model and therefore be low complexity. Monitoring an ML model based on joint input-output data distributions may be able to detect all three sources of data drift but may require running or using the ML model to perform inference, which may be high complexity, especially if the UE is monitoring the performance of multiple ML models.

A UE described herein may support techniques to monitor the performance of one or more ML models based on a labels data distribution or joint input-labels data distribution. In some examples, the UE may obtain ground-truth labels by measuring a reference signal. For example, the UE may measure an RSRP as prediction instances for temporal beam prediction. The UE may obtain the label information or measurement information for a prediction target to determine a statistical data distribution associated with label information, or actual measurement information obtained for the prediction resource during an inference period. The UE may compare the statistical data distribution associated with measurement information to a statistical data distribution associated with training label information, or training measurement information. In some examples, the UE may determine a joint distribution of input measurements and measurement labels, and the UE may compare the joint distribution of input measurements and measurement labels to a joint distribution of training inputs and training labels.

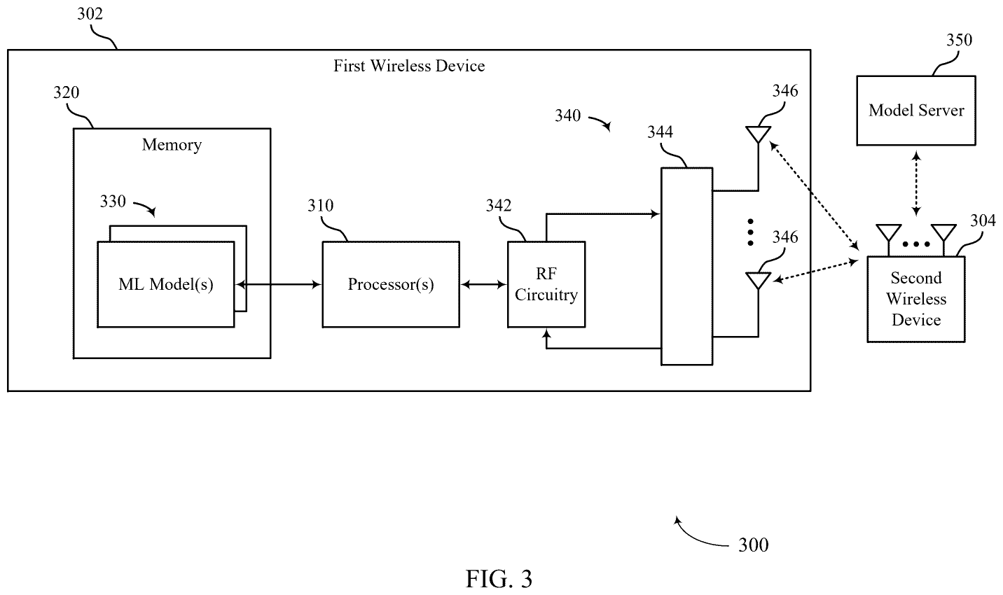

FIG. 3 shows an example ML architecture of first wireless device 302 that supports ML model monitoring in accordance with one or more aspects of the present disclosure. The first wireless device 302 may be in communication with second wireless device 304.

First wireless device 302 may be configured for monitoring a performance of an ML model based on a labels data distribution or a joint input-labels data distribution. Similarly, the second wireless device may be configured for capability signaling to indicate a capability to support monitoring the performance of an ML model based on a labels data distribution or a joint input-labels data distribution. In some examples, the second wireless device may be configured for reporting similarity information, such as a similarity metric or an indication of whether the similarity metric satisfies a threshold, associated with monitoring the performance of an ML model based on a labels data distribution or a joint input-labels data distribution. Additionally, or alternatively, the second wireless device may be configured for performing one or more operations, such as reselecting an ML model, retraining an ML model, or disabling inference techniques, in accordance with the similarity information or based on reporting the similarity information. Note that the example ML architecture of first wireless device 302 may be applied to second wireless device 304, and vice versa.

First wireless device 302 may be, or may include, a chip, system on chip (SoC), chipset, package or device that includes one or more processors, processing blocks or processing elements (collectively “processor 310”) and one or more memory blocks or elements (collectively “memory 320”). Processor 310 may be coupled to transceiver 340, which includes radio frequency (RF) circuitry 342 coupled to antennas 346 via interface 344, for transmitting or receiving signals.

One or more ML models 330 (collectively “ML model 330”) may be stored in memory 320 and accessible to processor(s) 310. Individual or groups of ML models 330 may be associated with respective model identifiers. In some aspects, different ML models 330, which may optionally be associated with different model identifiers, may have different characteristics. One or more ML models 330 may be selected based on respective features, characteristics, or applications, as well as characteristics or conditions of first wireless device 302 (such as, a power state, a mobility state, a battery reserve, a temperature, etc.). For example, ML models 330 may have different inference data and output pairings (such as, different types of inference data produce different types of output), different levels of accuracies associated with the predictions, different latencies associated with producing the predictions, different ML model sizes, different coefficients, different parameters, etc.

Processor 310 may deploy ML models 330 to produce respective output data based on input data. As an example, the ML model 330 may take measurements of a reference signal (such as, corresponding to a wide beam) as input to predict a channel characteristic associated with a different reference signal (such as, corresponding to a narrow beam within the wide beam, another wide beam, a narrow beam outside the wide beam, etc.). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, compressed CSI feedback or one or more predicted measurements (or characteristics) of one or more reference or pilot signals.

In some aspects, model server 350 may perform various ML management tasks for first wireless device 302 and/or second wireless device 304. For example, model server 350 may host various types and/or versions of ML models 330 for first wireless device 302 and/or second wireless device 304 to download. Model server 350 may monitor and evaluate the performance of ML model 330. Model server 350 may transmit signals or provide indications/instructions to activate or deactivate the use of a particular ML model at first wireless device 302 or second wireless device 304. Model server 350 may switch to a different ML model being used at first wireless device 302 or second wireless device 304, and model server 350 may provide such an instruction to the respective first wireless device 302 or second wireless device 304. Model server 350 may operate as a model training host and update ML model 330 using training data. In some cases, the model server 350 may operate as a data source to collect and host training data, inference data, performance feedback, etc., associated with ML model 330.

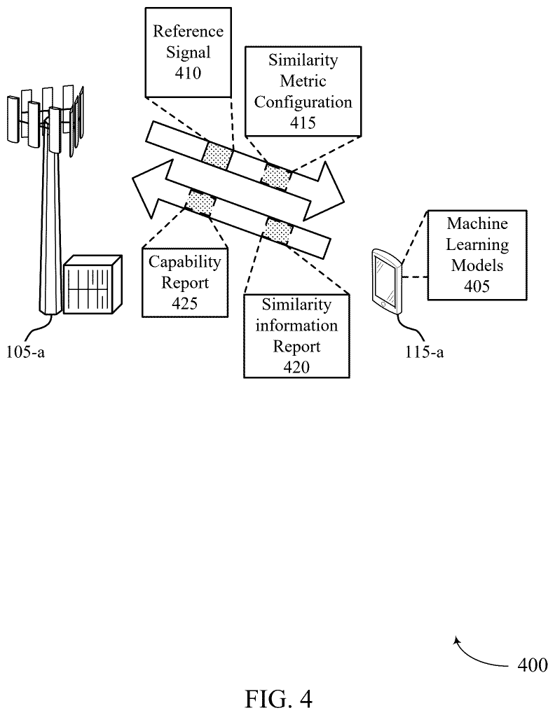

FIG. 4 shows an example of a wireless communications system 400 that supports ML model monitoring in accordance with one or more aspects of the present disclosure. The wireless communications system 400 may include a UE 115-a and a network entity 105-a, which may be respective examples of a UE 115 and a network entity 105 described herein.

The UE 115-a may be configured with one or more ML models 405. The one or more ML models 405 may be trained at the UE 115-a, such as prior to deployment of the UE 115-a in the wireless communications system 400. For example, the UE 115-a may be provided training input information for an ML model and corresponding label or training measurement information corresponding to the training input information. The training input information may, for example, be measurement information associated with measurement targets. The UE 115-a may generate an inference for a prediction target based on the training input information. The training measurement information may, for example, be an actual measurement of the prediction target. During training, the UE 115-a may input the training input information to an ML model, and the ML model may generate an output or an inference for a prediction target. The inference may be compared to the prediction measurement information or label information during training for finetuning the ML model, comparing the inference to the actual measurement information or label information of the prediction target.

The UE 115-a may use the one or more ML models 405 to generate inferences for prediction targets. In some examples, a time-frequency resource may be a prediction target. For example, the network entity 105-a may transmit reference signals via measurement targets, and the UE 115-a may measure the reference signals to obtain input information for an ML model. The UE 115-a may provide the input information to the ML model to generate an inference for a prediction target associated with the measurement targets. For example, the measurement targets may correspond to time-frequency resources of wide beams, and the prediction targets may correspond to time-frequency resources of narrow beams that are associated with the wide beams. The UE 115-a may input measurements of the wide beams to predict characteristics or measurements of the time-frequency resources of the narrow beams.

The wireless communications system 400 may support techniques for the UE 115-a or the network entity 105-a, or both, to monitor performance of the one or more ML models 405 based on measurement data distribution or label data distribution. For example, the network entity 105-a may configure the UE 115-a to monitor the one or more ML models 405 using labels distribution or joint input-labels distribution of the one or more ML models 405.

The UE 115-a may obtain label information, or actual measurement information for a prediction target, by measuring reference signals. The UE 115-a may monitor variations in the labels data distribution, or joint input-labels data distribution, and compare the label distribution data to corresponding data distributions used in training the one or more ML models 405 to determine applicability of the one or more ML models 405 to the operating conditions or environment of the UE 115-a.

These techniques may be different from monitoring the one or more ML models 405 using input data distributions or input-output data distributions. For example, instead of creating a data distribution based on input information (e.g., corresponding to measurement targets), the UE 115-a may create a data distribution based on label information (e.g., corresponding to prediction targets). For example, the UE 115-a may measure reference signals associated with a prediction target and create a data distribution based on measurement information for the prediction target.

For example, the UE 115-a may predict an RSRP for an SSB that is 100 milliseconds in the future for temporal beam selection. During an ML monitoring period, the UE 115-a may measure an RSRP of the SSB every 100 milliseconds. After multiple instances, the UE 115-a may have historical measurements of RSRP values at time t (e.g., corresponding to inputs to an ML model) and the RSRP values at time t+100 milliseconds (e.g., label information) for the multiple instances. The UE 115-a may construct a joint distribution of RSRPs at times t and at times t+100 milliseconds. The UE 115-a may monitor variations in the joint distribution of RSRPs at times t and t+100 milliseconds, and compare these distributions with training data distributions to determine an applicability of the ML model to the environment of the UE 115-a. The UE 115-a may not run the ML model or use the ML model to generate inferences, as the data distributions obtained during the ML monitoring period come from measurement target measurements and prediction target measurements. These techniques may be applied for other inference techniques, such as interference prediction, SINR prediction, and CSI prediction.

The network entity 105-a may transmit a reference signal 410 to the UE 115-a. For example, the UE 115-a may receive the reference signal via a prediction target resource associated with the one or more ML models 405. In some examples, UE 115-a may obtain measurement information for the prediction target based on measuring the reference signal 410.

The UE 115-a may determine a first statistical distribution corresponding to the measurement information for the prediction target. For example, the UE 115-a may have obtained multiple instances of measurement information for the prediction target over the ML monitoring period. The UE 115-a may determine one or more second statistical distributions based on the respective sets of training measurement information for the one or more ML models 405. For example, each ML model of the one or more ML models may have been trained using a set of training input information and a respective set of training measurement information, or label information.

The UE 115-a may compare the first statistical distribution corresponding to the measurement information for the prediction target to one or more second statistical distributions corresponding to training measurement information. The UE 115-a may obtain one or more similarity metrics based on the comparison. For example, the UE 115-a may compare the first statistical distribution corresponding to the measurement information to the one or more second statistical distributions corresponding to training measurement information to obtain a KL divergence, a KS distance, an Earth mover's distance, or any combination thereof. In some examples, a similarity metric may be based on one or more comparison techniques.

In some examples, the UE 115-a may be configured with a similarity threshold for comparing statistical distributions. For example, the network entity 105-a may transmit a control signal indicating a similarity metric configuration to the UE 115-a. The similarity metric configuration 415 may include one or more similarity metric thresholds. A similarity metric threshold may be used to determine how similar a first statistical distribution corresponding to measurement information is to one or more second statistical distributions corresponding to the one or more respective sets of training information, or the similarity metric threshold may be used to determine how dissimilar the first statistical distribution is to the one or more second statistical distributions. In some examples, the similarity metric configuration 415 may include one or more similarity thresholds associated with label data distributions or joint input-label distributions, or both. In some examples, the similarity metric configuration 415 may include one or more thresholds based on a KL divergence, a KD distance, an Earth mover's distance, or any combination thereof.

In some examples, the similarity metric configuration 415 may include different thresholds corresponding to different actions or operations. For example, the network entity 105-a may configure thresholds on the variations of the data distributions observed during inference exceeding a specific threshold. If the threshold is satisfied, the UE 115-a may be configured to take different actions. If the similarity metric satisfies a first threshold but not a second threshold, the UE 115-a may perform a first action. If the similarity metric satisfies both the first threshold and the second threshold, the UE 115-a may perform a second action.

In some examples, the UE 115-a may perform one or more operations based on the comparison or the similarity metric. In some examples, the UE 115-a may continue using a same ML model based on the comparison. For example, the UE 115-a may be using a first ML model to generate inferences. A statistical distribution of measurement information (e.g., obtained during an ML monitoring period) may be similar to a statistical distribution of training measurement information for the first ML model. If, for example, a similarity metric obtained by comparing the statistical distributions satisfies a threshold, the UE 115-a may continue using the first ML model for inferences.

In some examples, the UE 115-a may switch ML models based on the comparison. For example, the UE 115-a may use a first ML model to generate inferences. A statistical distribution of measurement information (e.g., obtained during an ML monitoring period) may be less similar to a statistical distribution of training measurement information for the first ML model than a statistical distribution of training measurement information for a second ML model. For example, a comparison to the statistical distribution of training measurement information for the first ML model may result in a first similarity metric that is smaller than a second similarity metric obtained from a comparison to the statistical distribution of training measurement information for the second ML model. The UE 115-a may switch to using the second ML model based on the first similarity metric failing to satisfy a first similarity metric, the second similarity metric satisfying a second similarity threshold, or both.

In some examples, the UE 115-a may finetune an ML model based on the comparison. In some examples, the UE 115-a may obtain additional training information for the ML model. For example, the UE 115-a may measure additional reference signals, or adjust layers, weights, or biases as described with reference to FIG. 2. In some examples, a similarity metric associated with a first ML model may satisfy a first similarity threshold but not a second similarity threshold. For example, a statistical distribution comparison for the first ML model may not be similar enough for the UE 115-a to continue using the ML model without adjustment but not dissimilar enough for the UE 115-a to disable artificial intelligence or ML operation. Additionally, or alternatively, comparisons of the statistical distribution of measurement information to statistical distributions of training measurement information for other ML models may have similar or worse similarity metrics.

In some examples, the UE 115-a may disable ML operation or fallback to non-ML operation based on the comparison. For example, the UE 115-a may obtain a similarity metric for each of the one or more ML models 405 using the techniques described herein. In some examples, none of the similarity metrics for any of the one or more ML models 405 may satisfy a similarity threshold. The UE 115-a may disable ML operation based on none of the similarity metrics satisfying the similarity threshold. Additionally, or alternatively, the UE 115-a may activate or deactivate certain branches in the one or more ML models 405 based on the comparison.

In some examples, the network entity 105-a may configure the UE 115-a to report similarity information. For example, the network entity 105-a may configure the UE 115-a to report the statistical distributions, similarity metrics for the one or more ML models, an indication of whether the one or more ML models 405 satisfy the one or more similarity thresholds, or any combination thereof. The UE 115-a may transmit an uplink message including a similarity information report 420. The similarity information report 420 may include statistical distributions associated with measurement information for the one or more ML models 405, similarity metrics associated with the one or more ML models 405, or whether any of the similarity metrics satisfy any of one or more similarity thresholds.

In some examples, the UE 115-a may report whether there is a change to a statistical distribution associated with measurement information for an ML model. For example, as operating conditions at the UE 115-a change, a statistical distribution corresponding to measurement information may change. The similarity information report 420 may indicate changes to the statistical distribution corresponding to measurement information.

The uplink message including the similarity information report 420 may be an uplink control information message, a MAC CE, or an RRC message. In some examples, the network entity 105-a may schedule the UE 115-a to transmit the uplink message including the similarity information report 420. For example, the network entity 105-a may configure the UE 115-a with uplink shared channel resources or uplink control channel resources to report changes in label data distributions.

The network entity 105-a may configure the UE 115-a to perform one or more operations based on the similarity information report 420. For example, the network entity 105-a may configure the UE 115-a to switch ML models, retrain an ML model, revert to non-ML operation, or any combination thereof, based on the similarity information report 420. The network entity 105-a may transmit an RRC message, a MAC CE, or a downlink control information message to configure the UE 115-a to transmit the similarity information report 420, perform one or more actions, or both.

In some examples, the UE 115-a may transmit a capability report 425 indicating that the UE 115-a has a capability to monitor the one or more ML models 405 using statistical distributions associated with label information or measurement information. In some examples, the capability report 425 may indicate that the UE 115-a supports using these techniques for monitoring an ML model used for beam prediction, CSI compression, positioning inference, or any combination thereof.

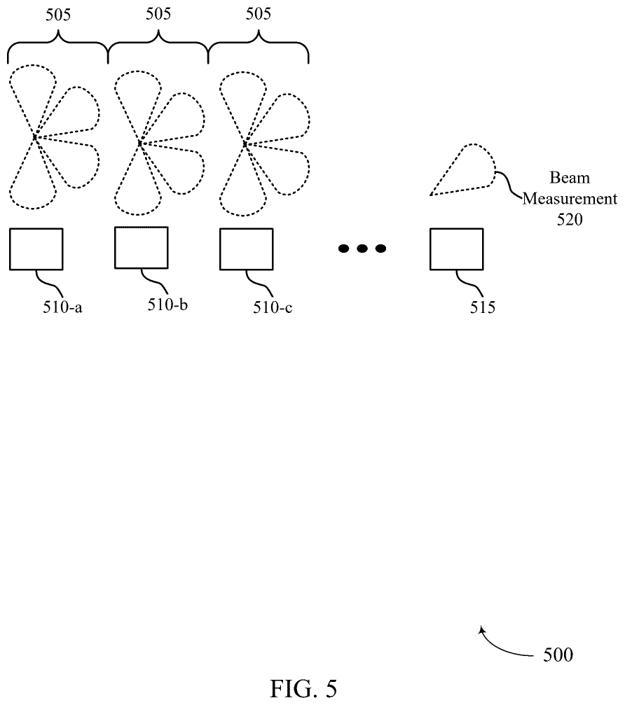

FIG. 5 shows an example of a drift detection technique 500 that supports ML model monitoring in accordance with one or more aspects of the present disclosure.

A network entity may transmit reference signals periodically to a UE via a measurement resource 510 using a set of beams 505, and the UE may predict a future best beam for a prediction target 515 based on historical measurements of the measurement resources 510. In some examples, the prediction target 515 may be a time-frequency resource that is 100 milliseconds in the future from a current measurement resource 510 or measurement target. For example, the measurement resource 510-c may correspond to time t, and the prediction target 515 may be 100 milliseconds after a measurement resource 510-c and correspond to time t+100 milliseconds. The UE may predict a best beam for the prediction target 515 based on the historical measurements of a measurement resource 510-a, a measurement resource 510-b, and the measurement resource 510-c.

The measurements of the measurement resources 510 may correspond to input information to an ML model of the UE. For example, the historical measurements of the measurement resources 510 may be input to the ML model, and the ML model may output a prediction of a best beam for the prediction target 515.

In some examples, the UE may experience data drift. For example, an environment or operating condition of the UE may change to be different from an environment or operating condition used to train an ML model. For example, the UE may change from an indoor environment to an outdoor environment. An ML model trained in an indoor environment may be less effective or accurate at creating predictions for an outdoor environment.

Some techniques may create a joint data distribution of ML model inputs and outputs for ML model monitoring. A UE may monitor changes in this joint data distribution to detect data drifts. However, creating a joint input-output data distribution may be based on running an ML model, which may increase complexity at the UE. If the UE monitors the performance of multiple ML models, the UE may generate inferences (e.g., outputs) for each ML model to create joint data distributions for each ML model.

The drift detection techniques 500 shows an example of monitoring the performance of one or more ML models configured at a UE by comparing a statistical distribution of measurement information obtained during inference to a statistical distribution of training information of the one or more ML models.

The UE may obtain measurement information for the prediction target 515. In some examples, the UE may measure a reference signal via the prediction target 515 to obtain measurement information for the prediction target 515. The measurement information for the prediction target 515 may be referred to as label information or ground-truth information. The UE 115 may determine a beam measurement 520 for a best beam during the prediction target 515. For example, the UE may obtain a measurement for the prediction target 515 (e.g., label information) instead of using an ML model to generate a prediction (e.g., output) for the prediction target 515. For example, at time t+200 milliseconds, the UE may have measurement information for the prediction target 515 at time t+100 and any additional prediction resources between time t+100 and t+200. For example, if the measurement resources 510 are periodic, the UE may have measurement information for six prediction resources at times t+100, t+120, t+140, t+160, t+180, and t+200 milliseconds.

In some examples, UE may determine a statistical distribution corresponding to the measurement information. For example, the UE may calculate a statistical data distribution of measurements for the prediction target 515 during an inference period.

Additionally, or alternatively, the UE may determine a joint distribution of input measurements and measurement labels. For example, the UE may determine a joint data distribution corresponding to both measurements of the measurement resources 510 and measurements of the prediction target 515. After several measurement instances, the UE may create a joint input-labels inference distribution.

The UE may monitor changes to the statistical data distribution (e.g., the label information statistical data distribution or the joint input-label statistical data distribution) to detect data drift. For example, if the statistical data distribution changes across inference periods or measurement instances, it may be an indicator that the UE is experiencing drift.

ML models configured at the UE may be trained with input information (e.g., input measurements of measurement targets) and label information (e.g., measurements of prediction targets). The UE may determine a statistical distribution of the label information for each of the one or more second ML models. In some examples, the training information may be configured at the UE prior to deployment of the UE. Additionally, or alternatively, the training information may be obtained during inference periods.

The UE may compare the statistical data distribution associated with measurement information of the prediction target 515 to one or more second statistical data distributions associated with training information. For example, the UE may determine a KL divergence, a KS distance, or an Earth mover's distance based on comparing the statistical distribution associated with measurement information of the prediction target 515 to each of the one or more statistical data distributions associated with training information for the one or more ML models.

In some examples, the UE may obtain one or more similarity metrics for each comparison. The UE may perform an operation or action based on the one or more similarity metrics. For example, the UE may keep using a same ML model for ML operation, the UE may switch to a different ML model, the UE may finetune one or more of the ML models, the UE may revert to non-ML operation, or the UE may activate or deactivate certain branches in the one or more ML models, or any combination thereof.

The drift detection technique 500 may be implemented to detect data drift for RSRP prediction techniques. However, similar techniques may be implemented for other prediction techniques. For example, for an SINR prediction, the UE may obtain input SINR measurements (e.g., corresponding to measurement targets) during an inference period. The UE may measure SINRs corresponding to prediction resources. For example, the UE may obtain SINRs for the prediction resources after 100 milliseconds. After several measurement instances, the UE may create a labels inference data distribution or a joint input-labels inference data distribution. The data distribution may be a multi-dimensional joint distribution of input SINRs and SINRs measured after 100 milliseconds during inference. The UE may observe changes in the data distribution to detect data drifts. In some examples, the UE may compare the data distribution to data distributions associated with training information to detect data drifts.

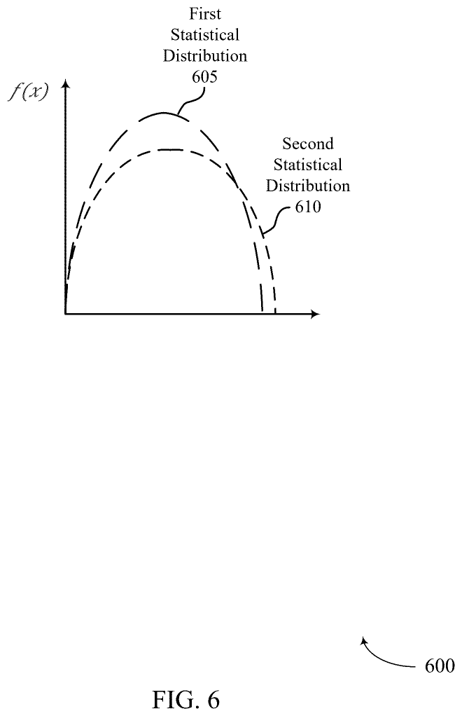

FIG. 6 shows an example of a data distribution comparison 600 that supports ML model monitoring in accordance with one or more aspects of the present disclosure.

The data distribution comparison 600 shows an example comparing a first statistical distribution 605 and a second statistical distribution 610. The first statistical distribution 605 may correspond to measurement information obtained during inference. For example, the first statistical distribution 605 may correspond to measurement information or label information of a prediction resource during an inference period. The second statistical distribution 610 may correspond to training information for an ML model. For example, the ML model may be trained on input information of measurement targets and label information or measurement information of prediction targets.

The UE may compare the first statistical distribution 605 to the second statistical distribution 610 to determine one or more similarity metric. For example, the UE may determine a KL divergence between the first statistical distribution 605 and the second statistical distribution 610. In some examples, the UE may determine a KS distance between the first statistical distribution 605 and the second statistical distribution 610. In some examples, the UE may determine an Earth mover's distance between the first statistical distribution 605 and the second statistical distribution 610. A similarity metric may be based on one or more of the KL divergence, the KS distance, and the Earth mover's distance, among other techniques or algorithms that may be used for comparison. In some examples, a similarity metric may correspond to how similar the statistical distributions are or how dissimilar the statistical distributions are.

In some examples, the UE may compare the first statistical distribution 605 to multiple second statistical distributions 610. For example, the UE may determine a second statistical distribution 610 for multiple ML models based on respective training information for the multiple ML models. The UE may determine one or more similarity metrics for each comparison.

The UE may perform an operation or action based on the one or more similarity metrics. For example, the UE may keep using a same ML model for ML operation, the UE may switch to a different ML model, the UE may finetune one or more of the ML models, the UE may revert to non-ML operation, or the UE may activate or deactivate certain branches in the one or more ML models, or any combination thereof.

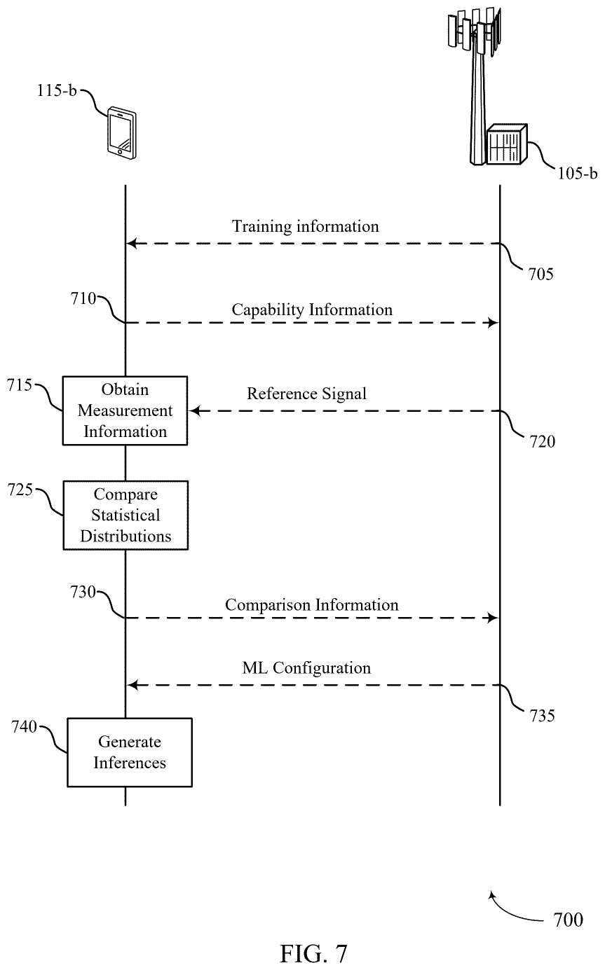

FIG. 7 shows an example of a process flow 700 that supports ML model monitoring in accordance with one or more aspects of the present disclosure. In some aspects, the process flow 700 may implement or be implemented by aspects of the wireless communication system 100, the ML model represented by the ANN 200, the ML architecture of the first wireless device 302, the wireless communications system 400, the drift detection technique 500, and the data distribution comparison 600 as described with reference to FIGS. 1-6. For example, the process flow 700 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 700, some aspects of some operations may also be performed by one or more other wireless devices.

The UE 115-b may be configured with training information for one or more ML models. In some examples, the network entity 105-b may configure the UE 115-b with the training information for the one or more ML models at 705. Additionally, or alternatively, the UE 115-b may be configured with the training information for the ML models prior to deployment in a wireless communications system. Additionally, or alternatively, the UE 115-b may obtain the training information during inference periods by generating inferences using the oner or more ML models.

In some examples, the UE 115-b may transmit capability information to the network entity 105-b at 710. For example, the UE 115-b may transmit a capability message that indicates a capability of the UE 115-b to compare a first statistical distribution associated with measurement information (e.g., label information for a prediction target) to one or more second statistical distributions associated with training information for one or more ML models.

At 715, the UE 115-b may obtain measurement information for a prediction target associated with the one or more ML models. For example, the network entity 105-b may transmit a reference signal via the prediction target at 720. The one or more ML models may be associated with one or more respective sets of training input information and one or more respective sets of training measurement information. The training input information may include training measurements for measurement targets, such as input RSRPs or input SINRs. The training measurement information may include training measurement information for prediction targets or label information.

The UE 115-b may determine a first statistical distribution corresponding to the measurement information. In some examples, the first statistical distribution also corresponds to input information associated with the measurement information. For example, the first statistical distribution may be a statistical distribution of label information or a statistical distribution of joint input-label information.

The UE 115-b may determine one or more second statistical distributions corresponding to the training information. For example, the UE 115-b may determine a statistical distribution for one or more ML models configured at the UE 115-b based on the training measurement information or label information. In some examples, the one or more second statistical distributions may also correspond to one or more respective sets of training input information for the one or more ML models.

At 725, the UE 115-b may compare the statistical distributions. For example, the UE 115-b may compare the first statistical distribution corresponding to the measurement information to the one or more second statistical distributions corresponding to the one or more respective sets of training measurement information to obtain one or more similarity metrics.

In some examples, the network entity 105-b may configure the UE 115-b with one or more similarity metric thresholds. For example, the UE 115-b may receive a first message indicating one or more similarity metric thresholds. The UE 115-b may compare the one or more similarity metrics to the one or more similarity metric thresholds.

The UE 115-b may perform an action or an operation based on the comparison. In some examples, the action or operation may be based on the one or more similarity metrics and the one or more similarity metric thresholds. For example, at 740, the UE 115-b may generate one or more inferences using a first ML model from among the one or more ML models. The UE 115-b may select the first ML model in accordance with the one or more similarity metrics. For example, a similarity metric corresponding to the ML model may satisfy a similarity metric threshold. In some examples, the UE 115-b may switch from using a second ML model to using the first ML model in accordance with the one or more similarity metrics. In some examples, the UE 115-b may monitor, in accordance with the one or more similarity metrics, for reference signals associated with the prediction target to obtain additional input information and additional measurement information for the first ML model, and the UE 115-b may adjust the first ML model or a corresponding statistical distribution for the first ML model, or both, in accordance with the additional input information and the additional measurement information.

The UE 115-b may report information associated with the comparison. In some examples, the network entity 105-b may configure the UE 115-b to report comparison information or similarity information. The UE 115-b may transmit comparison information at 730 to the network entity 105-b. For example, the UE 115-b may transmit indicative that the one or more similarity metrics satisfy the one or more similarity metric thresholds in accordance with the comparing. In some examples, the UE 115-b may indicate the similarity metrics or the statistical distributions, or both. For example, the comparison information may indicate at least one of the one or more similarity metrics, the first statistical distribution associated with the measurement information, or any combination thereof. In some examples, the UE 115-b may receive an ML configuration at 735, which may configure the UE 115-b to perform one or more operations or actions based on the comparison information. For example, the UE 115-b may perform the comparisons, and the network entity 105-b may determine an operation or action for the UE 115-b based on the comparison information. In other examples, the UE 115-b may determine the operation or action for the UE 115-b based on the comparison information.

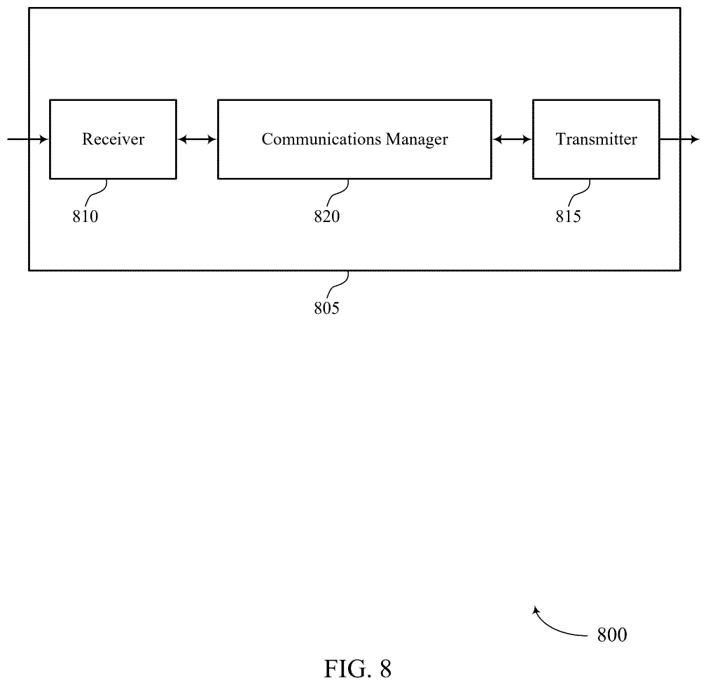

FIG. 8 shows a block diagram 800 of a device 805 that supports ML model monitoring in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to ML model monitoring). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to ML model monitoring). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of ML model monitoring as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining measurement information for a prediction target associated with one or more ML models, the one or more ML models associated with one or more respective sets of training input information and one or more respective sets of training measurement information. The communications manager 820 is capable of, configured to, or operable to support a means for comparing a first statistical distribution corresponding to the measurement information to one or more second statistical distributions corresponding to the one or more respective sets of training measurement information to obtain one or more similarity metrics. The communications manager 820 is capable of, configured to, or operable to support a means for generating one or more inferences using a first ML model from among the one or more ML models, where the first ML model is selected in accordance with the one or more similarity metrics.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and reduced power consumption.

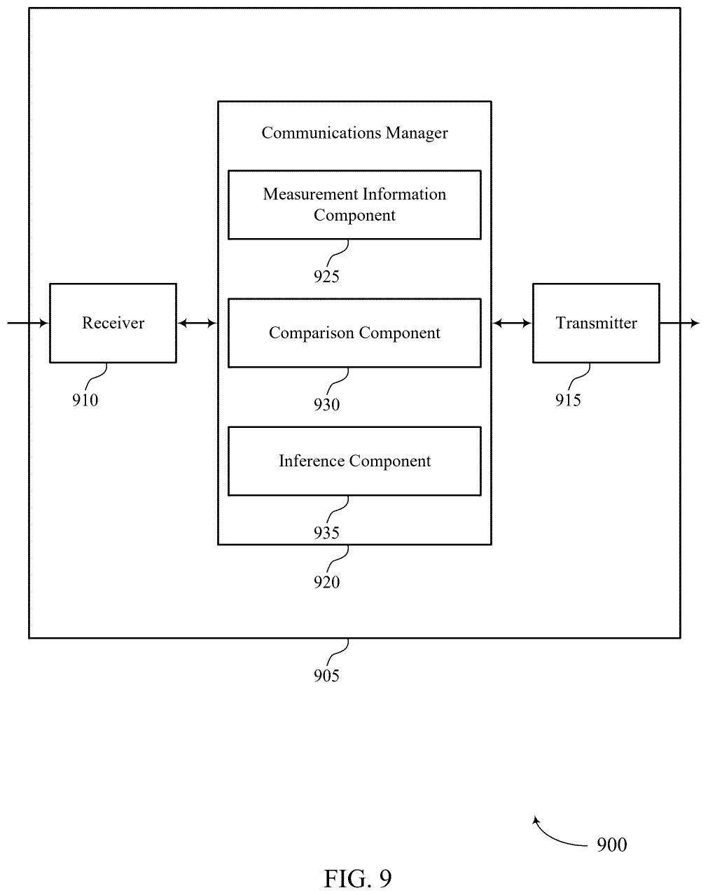

FIG. 9 shows a block diagram 900 of a device 905 that supports ML model monitoring in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to ML model monitoring). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to ML model monitoring). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of ML model monitoring as described herein. For example, the communications manager 920 may include a measurement information component 925, a comparison component 930, an inference component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The measurement information component 925 is capable of, configured to, or operable to support a means for obtaining measurement information for a prediction target associated with one or more ML models, the one or more ML models associated with one or more respective sets of training input information and one or more respective sets of training measurement information. The comparison component 930 is capable of, configured to, or operable to support a means for comparing a first statistical distribution corresponding to the measurement information to one or more second statistical distributions corresponding to the one or more respective sets of training measurement information to obtain one or more similarity metrics. The inference component 935 is capable of, configured to, or operable to support a means for generating one or more inferences using a first ML model from among the one or more ML models, where the first ML model is selected in accordance with the one or more similarity metrics.

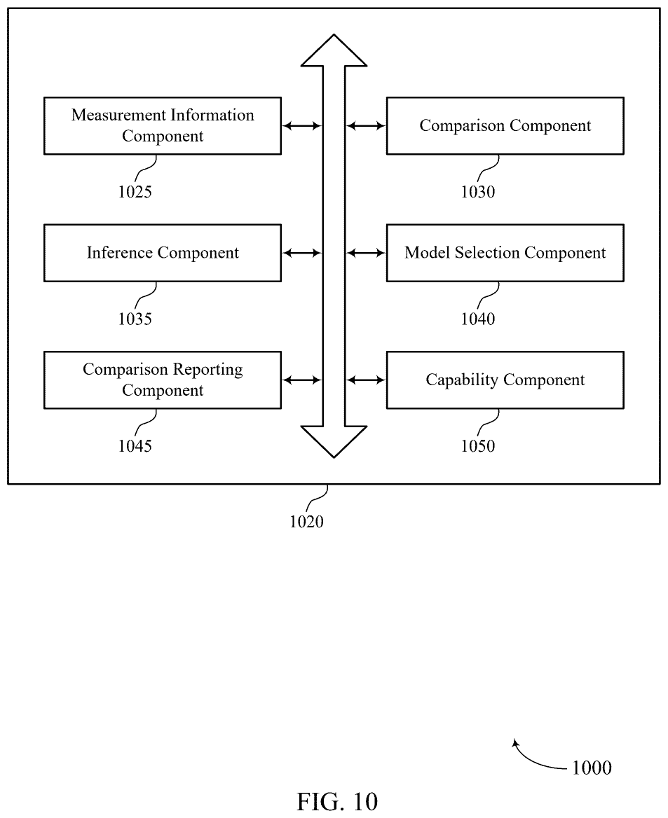

FIG. 10 shows a block diagram 1000 of a communications manager 1020 that supports ML model monitoring in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of ML model monitoring as described herein. For example, the communications manager 1020 may include a measurement information component 1025, a comparison component 1030, an inference component 1035, a model selection component 1040, a comparison reporting component 1045, a capability component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The measurement information component 1025 is capable of, configured to, or operable to support a means for obtaining measurement information for a prediction target associated with one or more ML models, the one or more ML models associated with one or more respective sets of training input information and one or more respective sets of training measurement information. The comparison component 1030 is capable of, configured to, or operable to support a means for comparing a first statistical distribution corresponding to the measurement information to one or more second statistical distributions corresponding to the one or more respective sets of training measurement information to obtain one or more similarity metrics. The inference component 1035 is capable of, configured to, or operable to support a means for generating one or more inferences using a first ML model from among the one or more ML models, where the first ML model is selected in accordance with the one or more similarity metrics.

In some examples, the first statistical distribution corresponds to input information associated with the measurement information, and the one or more second statistical distributions correspond to the one or more respective sets of training input information.

In some examples, to support obtaining the measurement information, the measurement information component 1025 is capable of, configured to, or operable to support a means for receiving a reference signal associated with the prediction target, where the measurement information is associated with a measurement of the reference signal via the prediction target.

In some examples, the model selection component 1040 is capable of, configured to, or operable to support a means for switching from using a second ML model to using the first ML model in accordance with the one or more similarity metrics.

In some examples, the measurement information component 1025 is capable of, configured to, or operable to support a means for monitoring, in accordance with the one or more similarity metrics, for reference signals associated with the prediction target to obtain additional input information and additional measurement information for the first ML model. In some examples, the inference component 1035 is capable of, configured to, or operable to support a means for adjusting the first ML model or a corresponding statistical distribution for the first ML model, or both, in accordance with the additional input information and the additional measurement information.

In some examples, the comparison component 1030 is capable of, configured to, or operable to support a means for receiving a first message indicating one or more similarity metric thresholds. In some examples, the comparison component 1030 is capable of, configured to, or operable to support a means for comparing the one or more similarity metrics to the one or more similarity metric thresholds, where the first ML model is selected in accordance with comparing the one or more similarity metrics to the one or more similarity metric thresholds.

In some examples, the comparison reporting component 1045 is capable of, configured to, or operable to support a means for transmitting a second message indicative that the one or more similarity metrics satisfy the one or more similarity metric thresholds in accordance with the comparing. In some examples, the model selection component 1040 is capable of, configured to, or operable to support a means for receiving a third message indicating the first ML model from among the one or more ML models in response to second message.

In some examples, the second message includes at least one of the one or more similarity metrics.

In some examples, the comparison reporting component 1045 is capable of, configured to, or operable to support a means for transmitting a control message indicating at least one of the one or more similarity metrics, the first statistical distribution associated with the measurement information, or any combination thereof.

In some examples, the comparison reporting component 1045 is capable of, configured to, or operable to support a means for receiving downlink control information scheduling a resource for the control message, where the control message is transmitted via the resource.

In some examples, the capability component 1050 is capable of, configured to, or operable to support a means for transmitting a capability message that indicates a capability of the first device to compare the first statistical distribution associated with the measurement information to the one or more second statistical distributions.

In some examples, the capability of the first device is associated with beam inferences, channel state information compression, positioning inferences, or any combination thereof.

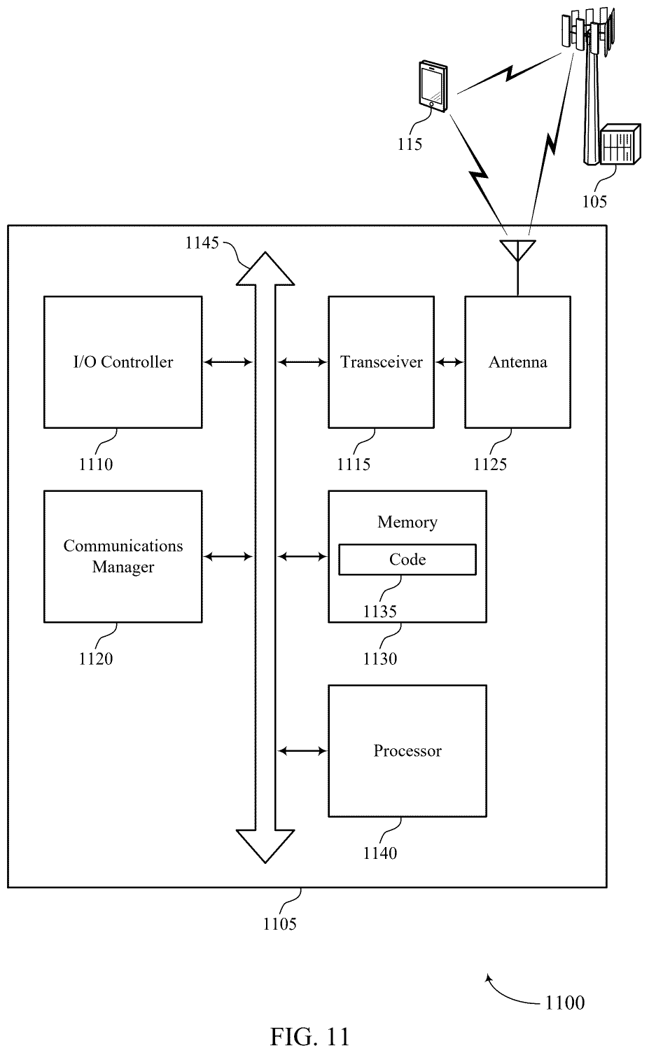

FIG. 11 shows a diagram of a system 1100 including a device 1105 that supports ML model monitoring in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting ML model monitoring). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for obtaining measurement information for a prediction target associated with one or more ML models, the one or more ML models associated with one or more respective sets of training input information and one or more respective sets of training measurement information. The communications manager 1120 is capable of, configured to, or operable to support a means for comparing a first statistical distribution corresponding to the measurement information to one or more second statistical distributions corresponding to the one or more respective sets of training measurement information to obtain one or more similarity metrics. The communications manager 1120 is capable of, configured to, or operable to support a means for generating one or more inferences using a first ML model from among the one or more ML models, where the first ML model is selected in accordance with the one or more similarity metrics.

By including or configuring the communications manager 1120 in accordance with examples as described herein, the device 1105 may support techniques improved user experience related to reduced processing, reduced power consumption, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of ML model monitoring as described herein, or the at least one processor 1140 and the at least one memory 1130 may be otherwise configured to, individually or collectively, perform or support such operations.

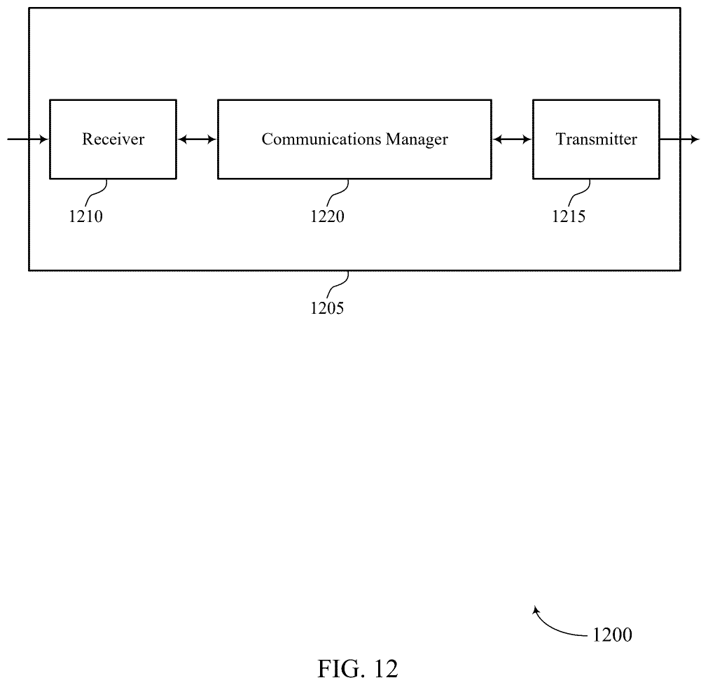

FIG. 12 shows a block diagram 1200 of a device 1205 that supports ML model monitoring in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of ML model monitoring as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting a reference signal associated with a prediction target for one or more ML models, the one or more ML models associated with one or more respective sets of training input information and one or more respective sets of training measurement information. The communications manager 1220 is capable of, configured to, or operable to support a means for obtaining first control message indicating one or more similarity metrics associated with comparison between a first statistical distribution corresponding to measurement information for the prediction target and one or more second statistical distributions corresponding to the one or more respective sets of training measurement information. The communications manager 1220 is capable of, configured to, or operable to support a means for outputting a second control message indicating a configuration for a first ML model from among the one or more ML models, where the first ML model is selected in accordance with the one or more similarity metrics.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing and reduced power consumption.

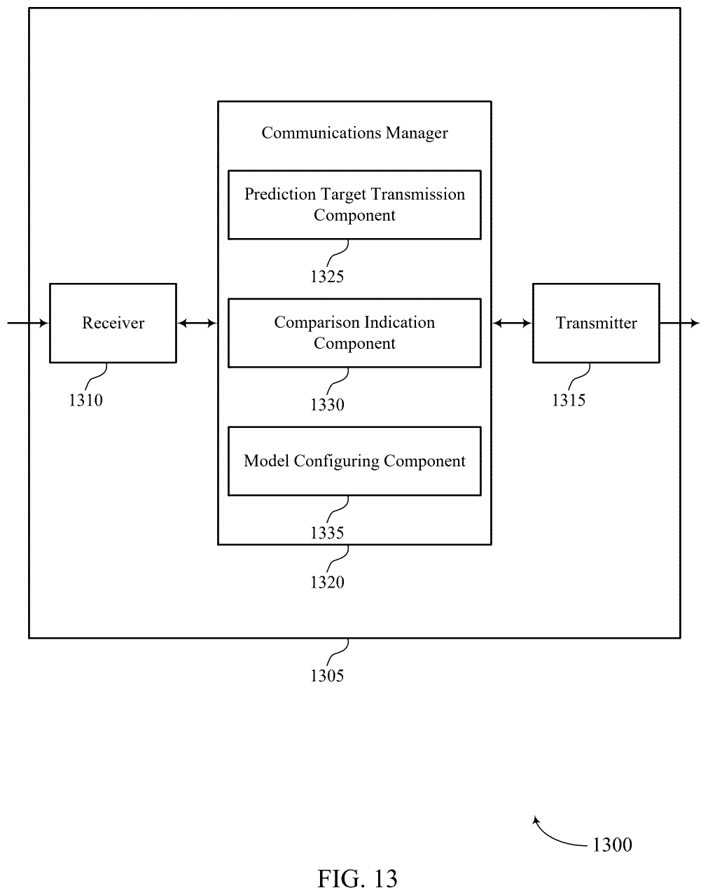

FIG. 13 shows a block diagram 1300 of a device 1305 that supports ML model monitoring in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of ML model monitoring as described herein. For example, the communications manager 1320 may include a prediction target transmission component 1325, a comparison indication component 1330, a model configuring component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The prediction target transmission component 1325 is capable of, configured to, or operable to support a means for outputting a reference signal associated with a prediction target for one or more ML models, the one or more ML models associated with one or more respective sets of training input information and one or more respective sets of training measurement information. The comparison indication component 1330 is capable of, configured to, or operable to support a means for obtaining first control message indicating one or more similarity metrics associated with comparison between a first statistical distribution corresponding to measurement information for the prediction target and one or more second statistical distributions corresponding to the one or more respective sets of training measurement information. The model configuring component 1335 is capable of, configured to, or operable to support a means for outputting a second control message indicating a configuration for a first ML model from among the one or more ML models, where the first ML model is selected in accordance with the one or more similarity metrics.

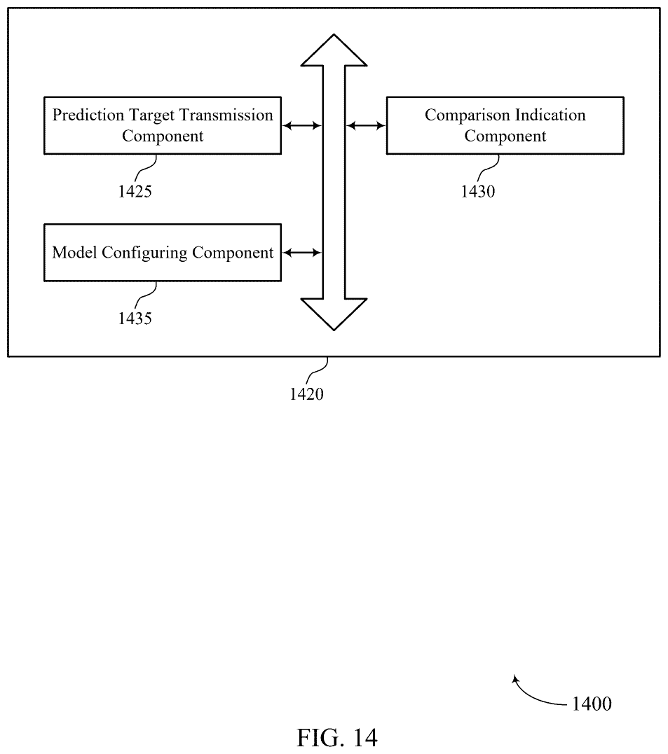

FIG. 14 shows a block diagram 1400 of a communications manager 1420 that supports ML model monitoring in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of ML model monitoring as described herein. For example, the communications manager 1420 may include a prediction target transmission component 1425, a comparison indication component 1430, a model configuring component 1435, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The prediction target transmission component 1425 is capable of, configured to, or operable to support a means for outputting a reference signal associated with a prediction target for one or more ML models, the one or more ML models associated with one or more respective sets of training input information and one or more respective sets of training measurement information. The comparison indication component 1430 is capable of, configured to, or operable to support a means for obtaining first control message indicating one or more similarity metrics associated with comparison between a first statistical distribution corresponding to measurement information for the prediction target and one or more second statistical distributions corresponding to the one or more respective sets of training measurement information. The model configuring component 1435 is capable of, configured to, or operable to support a means for outputting a second control message indicating a configuration for a first ML model from among the one or more ML models, where the first ML model is selected in accordance with the one or more similarity metrics.

In some examples, the first statistical distribution corresponds to input information associated with the measurement information, and the one or more second statistical distributions correspond to the one or more respective sets of training input information.

In some examples, the configuration for the first ML model indicates to use the first ML model, to disable the first ML model, to adjust the first ML model, or any combination thereof.

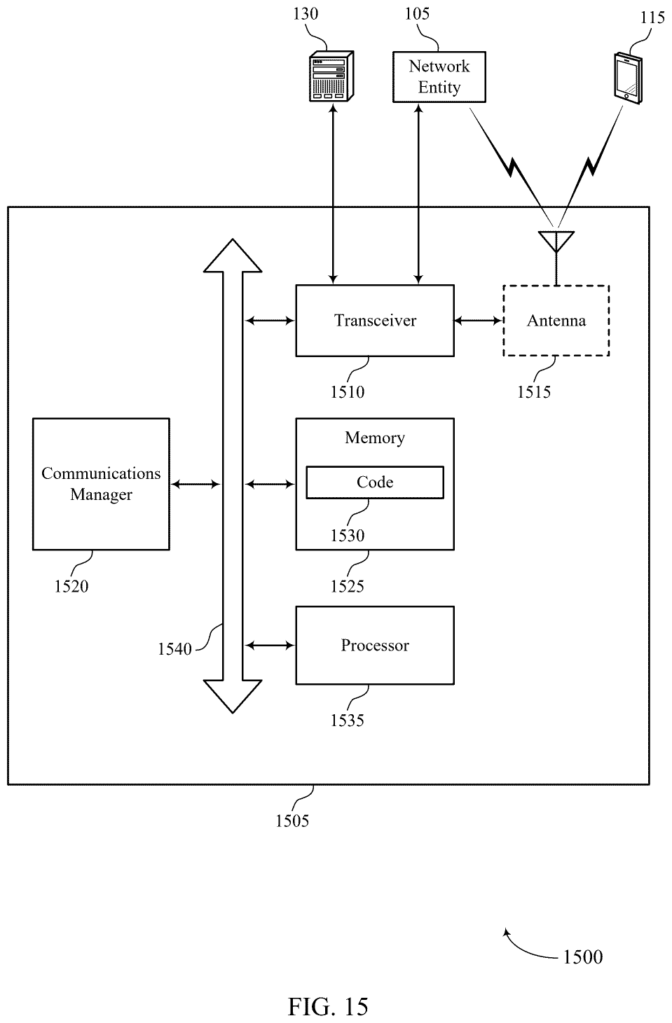

FIG. 15 shows a diagram of a system 1500 including a device 1505 that supports ML model monitoring in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting ML model monitoring). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting a reference signal associated with a prediction target for one or more ML models, the one or more ML models associated with one or more respective sets of training input information and one or more respective sets of training measurement information. The communications manager 1520 is capable of, configured to, or operable to support a means for obtaining first control message indicating one or more similarity metrics associated with comparison between a first statistical distribution corresponding to measurement information for the prediction target and one or more second statistical distributions corresponding to the one or more respective sets of training measurement information. The communications manager 1520 is capable of, configured to, or operable to support a means for outputting a second control message indicating a configuration for a first ML model from among the one or more ML models, where the first ML model is selected in accordance with the one or more similarity metrics.

By including or configuring the communications manager 1520 in accordance with examples as described herein, the device 1505 may support techniques for improved user experience related to reduced processing, reduced power consumption, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of ML model monitoring as described herein, or the at least one processor 1535 and the at least one memory 1525 may be otherwise configured to, individually or collectively, perform or support such operations.

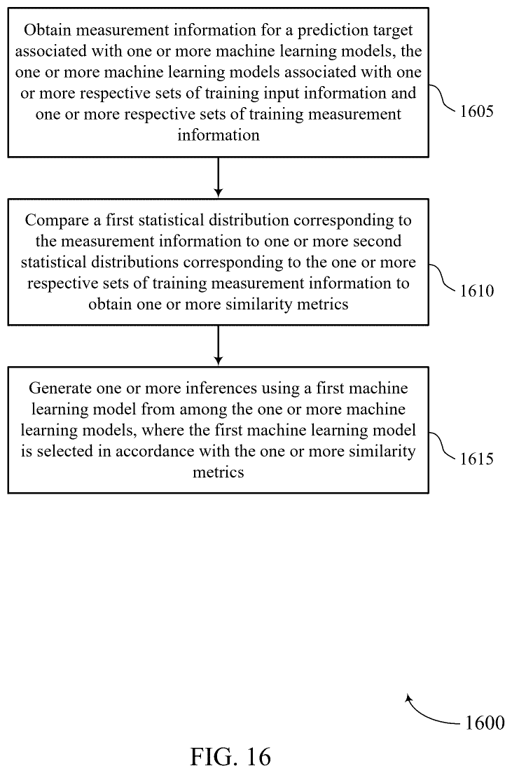

FIG. 16 shows a flowchart illustrating a method 1600 that supports ML model monitoring in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include obtaining measurement information for a prediction target associated with one or more ML models, the one or more ML models associated with one or more respective sets of training input information and one or more respective sets of training measurement information. The operations of 1605 may be performed in accordance with examples as disclosed herein. In some examples, aspects of the operations of 1605 may be performed by a measurement information component 1025 as described with reference to FIG. 10.

At 1610, the method may include comparing a first statistical distribution corresponding to the measurement information to one or more second statistical distributions corresponding to the one or more respective sets of training measurement information to obtain one or more similarity metrics. The operations of 1610 may be performed in accordance with examples as disclosed herein. In some examples, aspects of the operations of 1610 may be performed by a comparison component 1030 as described with reference to FIG. 10.

At 1615, the method may include generating one or more inferences using a first ML model from among the one or more ML models, where the first ML model is selected in accordance with the one or more similarity metrics. The operations of 1615 may be performed in accordance with examples as disclosed herein. In some examples, aspects of the operations of 1615 may be performed by an inference component 1035 as described with reference to FIG. 10.

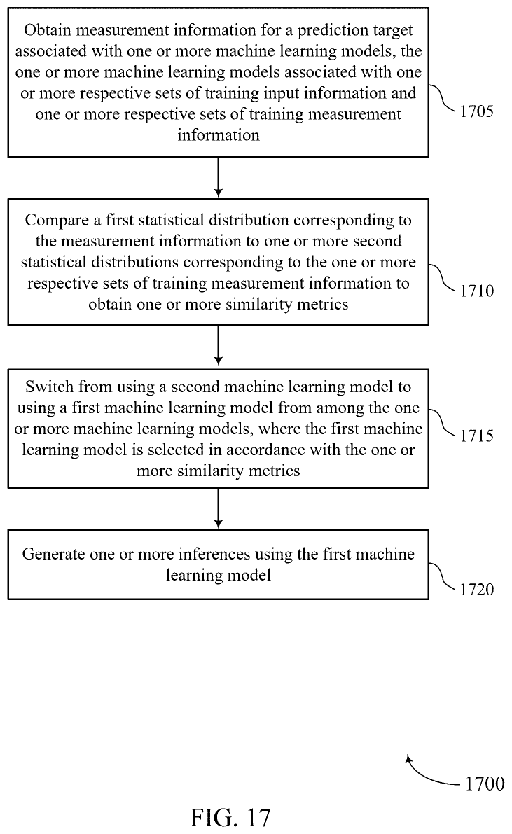

FIG. 17 shows a flowchart illustrating a method 1700 that supports ML model monitoring in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include obtaining measurement information for a prediction target associated with one or more ML models, the one or more ML models associated with one or more respective sets of training input information and one or more respective sets of training measurement information. The operations of 1705 may be performed in accordance with examples as disclosed herein. In some examples, aspects of the operations of 1705 may be performed by a measurement information component 1025 as described with reference to FIG. 10.

At 1710, the method may include comparing a first statistical distribution corresponding to the measurement information to one or more second statistical distributions corresponding to the one or more respective sets of training measurement information to obtain one or more similarity metrics. The operations of 1710 may be performed in accordance with examples as disclosed herein. In some examples, aspects of the operations of 1710 may be performed by a comparison component 1030 as described with reference to FIG. 10.

At 1715, the method may include switching from using a second machine learning model to using a first machine learning model from among the one or more machine learning models, where the first machine learning model is selected in accordance with the one or more similarity metrics. The operations of 1715 may be performed in accordance with examples as disclosed herein. In some examples, aspects of the operations of 1715 may be performed by a model selection component 1040 as described with reference to FIG. 10.

At 1720, the method may include generating one or more inferences using the first ML model. The operations of 1720 may be performed in accordance with examples as disclosed herein. In some examples, aspects of the operations of 1720 may be performed by an inference component 1035 as described with reference to FIG. 10.

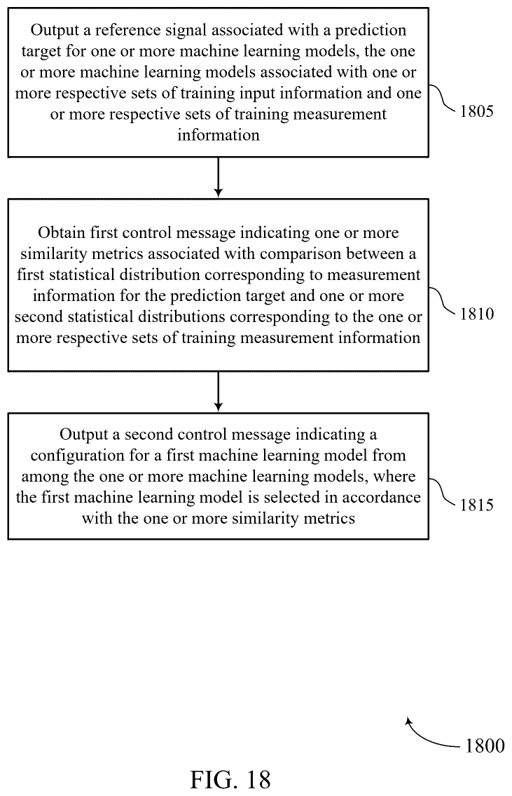

FIG. 18 shows a flowchart illustrating a method 1800 that supports ML model monitoring in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include outputting a reference signal associated with a prediction target for one or more ML models, the one or more ML models associated with one or more respective sets of training input information and one or more respective sets of training measurement information. The operations of 1805 may be performed in accordance with examples as disclosed herein. In some examples, aspects of the operations of 1805 may be performed by a prediction target transmission component 1425 as described with reference to FIG. 14.

At 1810, the method may include obtaining first control message indicating one or more similarity metrics associated with comparison between a first statistical distribution corresponding to measurement information for the prediction target and one or more second statistical distributions corresponding to the one or more respective sets of training measurement information. The operations of 1810 may be performed in accordance with examples as disclosed herein. In some examples, aspects of the operations of 1810 may be performed by a comparison indication component 1430 as described with reference to FIG. 14.

At 1815, the method may include outputting a second control message indicating a configuration for a first ML model from among the one or more ML models, where the first ML model is selected in accordance with the one or more similarity metrics. The operations of 1815 may be performed in accordance with examples as disclosed herein. In some examples, aspects of the operations of 1815 may be performed by a model configuring component 1435 as described with reference to FIG. 14.

The following provides an overview of aspects of the present disclosure:

Aspect 1: A method for wireless communications at a first device, comprising: obtaining measurement information for a prediction target associated with one or more machine learning models, the one or more machine learning models associated with one or more respective sets of training input information and one or more respective sets of training measurement information; comparing a first statistical distribution corresponding to the measurement information to one or more second statistical distributions corresponding to the one or more respective sets of training measurement information to obtain one or more similarity metrics; and generating one or more inferences using a first machine learning model from among the one or more machine learning models, wherein the first machine learning model is selected in accordance with the one or more similarity metrics.

Aspect 2: The method of aspect 1, wherein the first statistical distribution corresponds to input information associated with the measurement information, and the one or more second statistical distributions correspond to the one or more respective sets of training input information.

Aspect 3: The method of any of aspects 1 through 2, wherein obtaining the measurement information comprises: receiving a reference signal associated with the prediction target, wherein the measurement information is associated with a measurement of the reference signal via the prediction target.

Aspect 4: The method of any of aspects 1 through 3, further comprising: switching from using a second machine learning model to using the first machine learning model in accordance with the one or more similarity metrics.

Aspect 5: The method of any of aspects 1 through 4, further comprising: monitoring, in accordance with the one or more similarity metrics, for reference signals associated with the prediction target to obtain additional input information and additional measurement information for the first machine learning model; and adjusting the first machine learning model or a corresponding statistical distribution for the first machine learning model, or both, in accordance with the additional input information and the additional measurement information.

Aspect 6: The method of any of aspects 1 through 5, further comprising: receiving a first message indicating one or more similarity metric thresholds; and comparing the one or more similarity metrics to the one or more similarity metric thresholds, wherein the first machine learning model is selected in accordance with comparing the one or more similarity metrics to the one or more similarity metric thresholds.

Aspect 7: The method of aspect 6, further comprising: transmitting a second message indicative that the one or more similarity metrics satisfy the one or more similarity metric thresholds in accordance with the comparing; and receiving a third message indicating the first machine learning model from among the one or more machine learning models in response to second message.

Aspect 8: The method of aspect 7, wherein the second message comprises at least one of the one or more similarity metrics.

Aspect 9: The method of any of aspects 1 through 8, further comprising: transmitting a control message indicating at least one of the one or more similarity metrics, the first statistical distribution associated with the measurement information, or any combination thereof.

Aspect 10: The method of aspect 9, further comprising: receiving downlink control information scheduling a resource for the control message, wherein the control message is transmitted via the resource.

Aspect 11: The method of any of aspects 1 through 10, further comprising: transmitting a capability message that indicates a capability of the first device to compare the first statistical distribution associated with the measurement information to the one or more second statistical distributions.

Aspect 12: The method of aspect 11, wherein the capability of the first device is associated with beam inferences, channel state information compression, positioning inferences, or any combination thereof.

Aspect 13: A method for wireless communications at a second device, comprising: outputting a reference signal associated with a prediction target for one or more machine learning models, the one or more machine learning models associated with one or more respective sets of training input information and one or more respective sets of training measurement information; obtaining first control message indicating one or more similarity metrics associated with comparison between a first statistical distribution corresponding to measurement information for the prediction target and one or more second statistical distributions corresponding to the one or more respective sets of training measurement information; and outputting a second control message indicating a configuration for a first machine learning model from among the one or more machine learning models, wherein the first machine learning model is selected in accordance with the one or more similarity metrics.

Aspect 14: The method of aspect 13, wherein the first statistical distribution corresponds to input information associated with the measurement information, and the one or more second statistical distributions correspond to the one or more respective sets of training input information.

Aspect 15: The method of any of aspects 13 through 14, wherein the configuration for the first machine learning model indicates to use the first machine learning model, to disable the first machine learning model, to adjust the first machine learning model, or any combination thereof.

Aspect 16: A first device for wireless communications, comprising one or more memories storing processor-executable code, and one or more processors coupled with the one or more memories and individually or collectively operable to execute the code to cause the first device to perform a method of any of aspects 1 through 12.

Aspect 17: A first device for wireless communications, comprising at least one means for performing a method of any of aspects 1 through 12.

Aspect 18: A non-transitory computer-readable medium storing code for wireless communications, the code comprising instructions executable by one or more processors to perform a method of any of aspects 1 through 12.

Aspect 19: A second device for wireless communications, comprising one or more memories storing processor-executable code, and one or more processors coupled with the one or more memories and individually or collectively operable to execute the code to cause the second device to perform a method of any of aspects 13 through 15.

Aspect 20: A second device for wireless communications, comprising at least one means for performing a method of any of aspects 13 through 15.

Aspect 21: A non-transitory computer-readable medium storing code for wireless communications, the code comprising instructions executable by one or more processors to perform a method of any of aspects 13 through 15. It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first device, comprising:
one or more memories storing processor-executable code; and
one or more processors coupled with the one or more memories and individually or collectively operable to execute the code to cause the first device to:
obtain measurement information for a prediction target associated with one or more machine learning models, the one or more machine learning models associated with one or more respective sets of training input information and one or more respective sets of training measurement information;
compare a first statistical distribution corresponding to the measurement information to one or more second statistical distributions corresponding to the one or more respective sets of training measurement information to obtain one or more similarity metrics; and
generate one or more inferences using a first machine learning model from among the one or more machine learning models, wherein the first machine learning model is selected in accordance with the one or more similarity metrics.

2. The first device of claim 1, wherein the first statistical distribution corresponds to input information associated with the measurement information, and the one or more second statistical distributions correspond to the one or more respective sets of training input information.

3. The first device of claim 1, wherein, to obtain the measurement information, the one or more processors are individually or collectively operable to execute the code to cause the first device to:
receive a reference signal associated with the prediction target, wherein the measurement information is associated with a measurement of the reference signal via the prediction target.

4. The first device of claim 1, wherein the one or more processors are individually or collectively further operable to execute the code to cause the first device to:
switch from using a second machine learning model to using the first machine learning model in accordance with the one or more similarity metrics.

5. The first device of claim 1, wherein the one or more processors are individually or collectively further operable to execute the code to cause the first device to:
monitor, in accordance with the one or more similarity metrics, for reference signals associated with the prediction target to obtain additional input information and additional measurement information for the first machine learning model; and
adjust the first machine learning model or a corresponding statistical distribution for the first machine learning model, or both, in accordance with the additional input information and the additional measurement information.

6. The first device of claim 1, wherein the one or more processors are individually or collectively further operable to execute the code to cause the first device to:
receive a first message indicating one or more similarity metric thresholds; and
compare the one or more similarity metrics to the one or more similarity metric thresholds, wherein the first machine learning model is selected in accordance with comparing the one or more similarity metrics to the one or more similarity metric thresholds.

7. The first device of claim 6, wherein the one or more processors are individually or collectively further operable to execute the code to cause the first device to:
transmit a second message indicative that the one or more similarity metrics satisfy the one or more similarity metric thresholds in accordance with the comparing; and
receive a third message indicating the first machine learning model from among the one or more machine learning models in response to second message.

8. The first device of claim 7, wherein the second message comprises at least one of the one or more similarity metrics.

9. The first device of claim 1, wherein the one or more processors are individually or collectively further operable to execute the code to cause the first device to:
transmit a control message indicating at least one of the one or more similarity metrics, the first statistical distribution associated with the measurement information, or any combination thereof.

10. The first device of claim 9, wherein the one or more processors are individually or collectively further operable to execute the code to cause the first device to:
receive downlink control information scheduling a resource for the control message, wherein the control message is transmitted via the resource.

11. The first device of claim 1, wherein the one or more processors are individually or collectively further operable to execute the code to cause the first device to:
transmit a capability message that indicates a capability of the first device to compare the first statistical distribution associated with the measurement information to the one or more second statistical distributions.

12. The first device of claim 11, wherein the capability of the first device is associated with beam inferences, channel state information compression, positioning inferences, or any combination thereof.

13. A second device, comprising:
one or more memories storing processor-executable code; and
one or more processors coupled with the one or more memories and individually or collectively operable to execute the code to cause the second device to:
output a reference signal associated with a prediction target for one or more machine learning models, the one or more machine learning models associated with one or more respective sets of training input information and one or more respective sets of training measurement information;
obtain first control message indicating one or more similarity metrics associated with comparison between a first statistical distribution corresponding to measurement information for the prediction target and one or more second statistical distributions corresponding to the one or more respective sets of training measurement information; and
output a second control message indicating a configuration for a first machine learning model from among the one or more machine learning models, wherein the first machine learning model is selected in accordance with the one or more similarity metrics.

14. The second device of claim 13, wherein the first statistical distribution corresponds to input information associated with the measurement information, and the one or more second statistical distributions correspond to the one or more respective sets of training input information.

15. The second device of claim 13, wherein the configuration for the first machine learning model indicates to use the first machine learning model, to disable the first machine learning model, to adjust the first machine learning model, or any combination thereof.

16. A method for wireless communications at a first device, comprising:
obtaining measurement information for a prediction target associated with one or more machine learning models, the one or more machine learning models associated with one or more respective sets of training input information and one or more respective sets of training measurement information;
comparing a first statistical distribution corresponding to the measurement information to one or more second statistical distributions corresponding to the one or more respective sets of training measurement information to obtain one or more similarity metrics; and
generating one or more inferences using a first machine learning model from among the one or more machine learning models, wherein the first machine learning model is selected in accordance with the one or more similarity metrics.

17. The method of claim 16, wherein the first statistical distribution corresponds to input information associated with the measurement information, and the one or more second statistical distributions correspond to the one or more respective sets of training input information.

18. The method of claim 16, wherein obtaining the measurement information comprises:
receiving a reference signal associated with the prediction target, wherein the measurement information is associated with a measurement of the reference signal via the prediction target.

19. The method of claim 16, further comprising:
switching from using a second machine learning model to using the first machine learning model in accordance with the one or more similarity metrics.

20. The method of claim 16, further comprising:
monitoring, in accordance with the one or more similarity metrics, for reference signals associated with the prediction target to obtain additional input information and additional measurement information for the first machine learning model; and
adjusting the first machine learning model or a corresponding statistical distribution for the first machine learning model, or both, in accordance with the additional input information and the additional measurement information.
